(19) United States
(12) Patent Application Publication
(10) Pub. No.: US 2006/0271438 A1
(43) Pub. Date: Nov. 30, 2006

(54) Advertising systems and methods

(76) Inventors: Andrew Shotland, Pasadena, CA (US); Robert Sego, Pasadena, CA (US)

Correspondence Address: COURTNEY STANIFORD & GREGORY LLP, P.O. BOX 9686, SAN JOSE, CA, 95157, US

(21) Appl. No.: 11/440,737

(22) Filed: May 24, 2006

Related U.S. Application Data
(60) Provisional application No. 60/684,286, filed on May 24, 2005.

(51) Int. Cl. G06G 7/00; G06F 17/00

(52) U.S. Cl. 705/14; 705/400

(57) ABSTRACT

Advertising systems and methods are described that are configured to receive bid requests for ad placement. The bid requests include a bid amount and an ad type, category, and/or geographic area. The ad type includes click ads, call ads, and/or call and click ads. Ad pricing is determined for ad placement using the bid requests in a dynamic price auction. The ad pricing includes a floor price and/or another ad price. The advertising systems and methods are configured to periodically modify the ad pricing according to price correlation data among ads having different ad types. Ad pricing also includes optional fixed-price advertising for set time periods for a subset of advertisers based on auction bid prices. One or more ads are placed in electronic ad spots according to the ad pricing. Search results that include the placed ads are presented in response to a user search queries.

### RELATED APPLICATION

This application claims the benefit of U.S. Patent Application No. 60/684,286, filed May 24, 2005.

### FIELD OF THE INVENTION

The present invention is related to electronic advertising and, more particularly, to advertising auction systems and search systems.

### BACKGROUND

The proliferation of electronic devices along with the continued growth of electronic commerce and information exchange has continued at an extreme pace. Consumers therefore continue to turn to the World Wide Web (Web) in record numbers to gather information on various goods, services, and activities relating to all aspects of their lives. This has resulted in a corresponding increase in the amount of advertising and other information available on the Web. Consequently, there is a need for an efficient pricing mechanism for allocating electronic advertising inventory and at the same time maximizing ad revenues for entities involved in electronic advertising.

### INCORPORATION BY REFERENCE

Each publication, patent, and/or patent application mentioned in this specification is herein incorporated by reference in its entirety to the same extent as if each individual publication and/or patent application was specifically and individually indicated to be incorporated by reference.

### BRIEF DESCRIPTION OF THE DRAWINGS

FIG. 1 is a block diagram of a search and advertising auction (SAA) system, in accordance with an embodiment.

FIG. 2 shows a block diagram of an information manager, in accordance with an embodiment.

FIG. 3 is a block diagram of a client user or advertiser device, under an embodiment.

FIG. 4 is a schematic of ad types, under an embodiment.

FIGS. 5A-5E show how a personal contact network is created incorporating the advertising features, under an embodiment.

FIG. 6 shows the example embodiments of a click ad type, a call ad type, and a call and click ad type listing, under an embodiment.

FIG. 7 is an example user search, under an embodiment.

FIG. 8 is another example of a search result page, under an embodiment.

FIG. 9 is an example business profile page, under an embodiment.

FIG. 10 is another example business profile page, under an embodiment.

FIG. 11 is an example web page shown to potential advertisers, under an embodiment.

FIG. 12 is an example page enabling a user to enter a search parameter so that a user may post a review, under an embodiment.

FIG. 13 is an example page enabling a user to post a review within the SAA system, under an embodiment.

FIG. 14 is an example user interface enabling an advertiser to place a bid for an ad listing, under an embodiment.

FIG. 15 is a schematic block diagram of how a user search is related to paid ad listings, under an embodiment.

FIG. 16A and FIG. 16B are display tables showing example portions of a database that include ad bids, under an embodiment.

FIG. 17 shows example display table embodiments of the dynamic second price auction feature, under an embodiment.

FIG. 18 shows a two-phase implementation of a scheme or process that approximately equalizes the potential revenues and/or profits from the call ad and the click ad types, under an embodiment.

FIGS. 19A and 19B show an example price correlation formula, used in accordance with an embodiment.

FIG. 20 is an example interface enabling sales representatives, for example, to enter fixed price orders or telesales auction bids on behalf of advertisers, under an embodiment.

FIG. 21 shows a schematic block diagram of the available ad inventory and how such ad inventory is allocated, under an embodiment.

### DETAILED DESCRIPTION OF THE INVENTION

Systems and methods are described for advertising. The advertising systems and methods, collectively referred to herein as advertising systems, are configured to receive bid requests for advertisement (ad) placement. The bid requests include a bid amount and one or more of an ad type, a category, and a geographic area. The ad type includes click ad types, a call ad types, and/or call and click ad types. Ad pricing is determined for the ad placement using the bid requests in a dynamic price auction. The ad pricing includes a floor price and/or another ad price. The advertising systems and methods are configured to periodically modify the ad pricing according to price correlation data among ads having different ad types. One or more ads are placed in electronic ad spots according to the ad pricing. Search results that include the placed ads are presented in response to a user search queries.

In the following description, numerous specific details are introduced to provide a thorough understanding of, and enabling description for, embodiments of the advertising systems. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

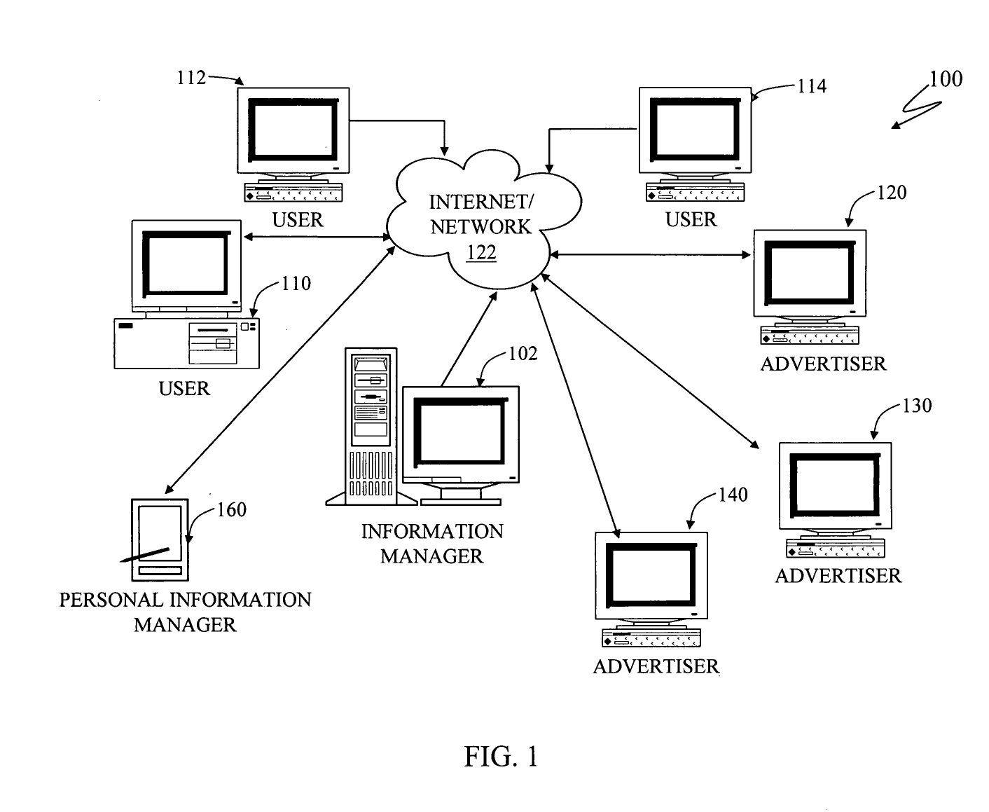

FIG. 1 is a block diagram of a search and advertising auction (SAA) system 100, in accordance with an embodiment. This SAA system 100 in general enables users to post reviews about entities, particularly business entities, such as service and product providers.

Other entities may include travel spots, products, parks, theme spots, and the like. Users are also enabled to search by providing search parameter that generally consists of a keyword and a target location, e.g., such as searching for “restaurants” within zip code “90017.” The keyword may also be a combination of words and/or any string combination, such as “Chinese restaurant.” In an embodiment, the users of the SAA system may have relationships with each other, such as being a user's direct friend or a friend of a friend. Reviews in general are any user-provided information, including, but not limited to, ratings, feedbacks, recommendations, comments, and feedbacks on feedbacks. In an embodiment, the SAA system 100 enables advertisers to bid for advertising spots. Advertisers are also enabled to access and update information contained in the information manager 102, particularly those related to advertising. When a user posts a search request, the SAA system 100, particularly the information manager 102, provides one or more search results, with one or more paid advertisements. Such advertisements include any information that may be presented to users and may even include non-conventional advertisement information, such as news, literature, opinions, and quotations.

The SAA system 100 in one embodiment includes an information manager 102, which can be a server, wherein several client devices, for example computer/computing devices or terminals 110, 112, 114, 120, 130, 140, 160 are coupled to the information manager 102 via a wired or wireless data and/or communications network 122, such as the Internet, an intranet, a virtual private network, and a local or wide area network. The information manager 102 functions as a website and may include one or more servers connected via a network. In general, the users and advertisers of the SAA system 100 connect with the information manager 102, which serves up web pages and implements the features of the present invention. The client computer systems or devices may be users of the network 110, 112, 114, 160 or advertisers 120, 130, 140. These client devices 110, 112, 114, 120, 130, 140 may also be other network-enabled devices 160, including, but not limited to, Web-enabled wireless phones, personal digital assistants (PDAs), smart phones, Internet-enabled game devices—XBOX's™ and PlayStation's™, and interactive televisions. These client devices enable users and/or advertisers to interface with the information manager 102 using various mechanisms, including, but not limited to, keyboard entries, voice-activated commands, touch-tone phone interfaces, and touch screens.

The SAA system 100 in one embodiment includes a telecommunications system, not shown, that accepts and routes calls to advertisers. This telecommunications system may in one embodiment be directly and interactively connected to the information manager. In an embodiment, the telecommunications system is not directly connected with the information manager, e.g., a stand-alone system operating outside of the network 122 but operating within a phone network. The telecommunications system, in one embodiment, keeps track of all calls made by users to advertisers, and records such information, for example, in a database. Examples of such telecommunications systems include Voice Response Units (VRUs) or other phone systems, e.g., using the Voice Extensible Markup Language (Voice XML) and/or Call Control Extensible Markup Language (CCXML).

In one aspect of the invention, an advertiser may bid for one or more available advertising spots by calling a sales representative and placing such bid with that representative. In this embodiment, a regular phone system—even a phone line, or any other phone-like systems/devices (not shown), such as voice over Internet protocol (VOIP) devices, may be used by advertisers to communicate with sales representatives. Thus, advertisers in an embodiment may utilize the advertising bidding features of the present invention, such as placing bids, without utilizing a computing device, such as a computer.

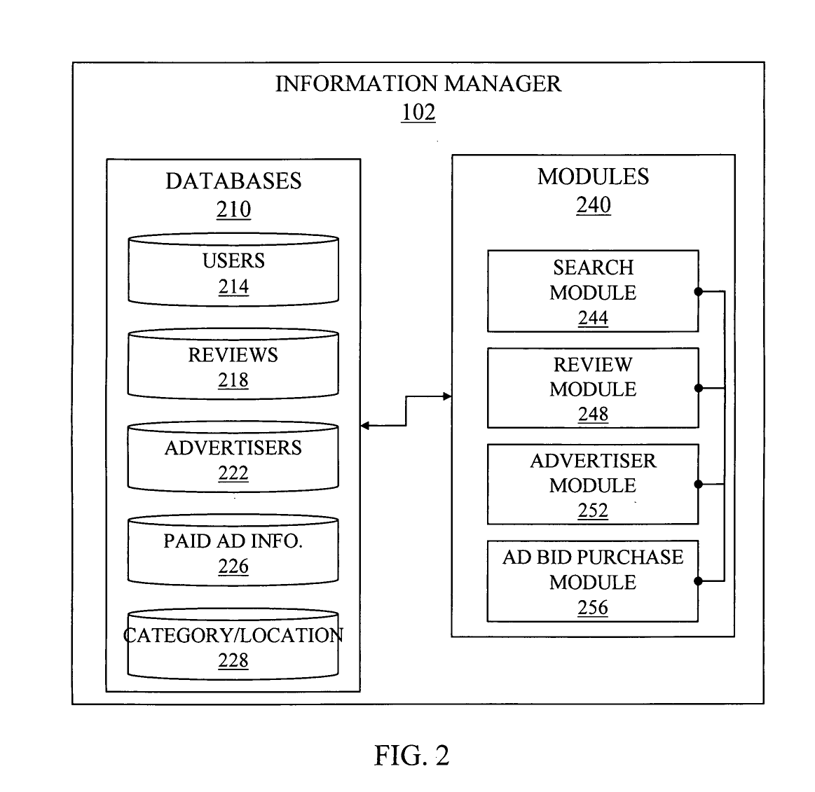

FIG. 2 shows a block diagram of an information manager 102, including example modules 240 and databases 210, in accordance with an embodiment. These various modules 240 may be replicated and/or distributed over one or more servers, and in general are sets of program codes, functions, processes, program instructions, and/or applications that are executable by computing devices, like computers, to perform the features of the present invention. These modules interface with each other.

The users database 214 generally includes user-related information, which may include, for example, user name, password, relationships with other users, and demographic information. The reviews database 218 generally contains reviews posted by users 218. The advertisers database 222 generally contains advertiser-related information, which may include, for example, advertiser name, password, location address, website address, and email address. The ad information database 226 generally contains paid ad-related information, such as current active bidders on advertising spots based on categories and location/area, floor price, ad statistic information, conversion rate, and click-through rate. The category/location database 228 stores the index of category and location combinations on which ad listings are based. Therefore, the category/location database 228 stores the available category and location combinations, which advertisers bid on for advertising purposes. Other databases may also be included, for example, a businesses/entities database containing information, such as company name, address, phone number, and fax number. These businesses are generally those entities that users review. Other data elements and databases not mentioned may also be included. In an embodiment, these databases are stored in an RDBMS, for example as tables.

The information manager 102 includes a search module 244, a review module 248, an advertiser module 252, and an ad bid purchase module 256. These modules 240 generally interface with the databases 210, particularly reading and writing data into such databases 210. The search module 244 generally receives and responds to user search requests. The review module 248 enables users to post and manage reviews, such as posting reviews and editing reviews. The advertiser module 252 enables advertisers to provide and update advertiser-related information, such as advertiser's name, address, phone number, email address, and website address. The ad bid purchase module 256 enables advertisers to bid on advertising spots. Other modules not shown may also be included, such as a relationship module that updates the relationships between users, a billing module that keeps track of monies due to the operator of the SAA system, and the like. In an embodiment, the information manager 102 also includes a web server module that dynamically generates web pages that may be served to users and advertisers of the SAA system 100. One of ordinary skill in the art will realize that modules and databases incorporated in the information manager may vary depending on system implementation and design. Furthermore, some features described herein, which are utilized or performed by advertisers, may be performed in behalf of the advertisers, for example, by sales representatives. Advertisers, for example, who are not computer users may still update advertiser-related information by calling, for example, sales representatives or data input clerks who then accordingly update on-line advertiser-related information. In one embodiment, such updates may be sent by advertisers via regular mail using printed forms, for example.

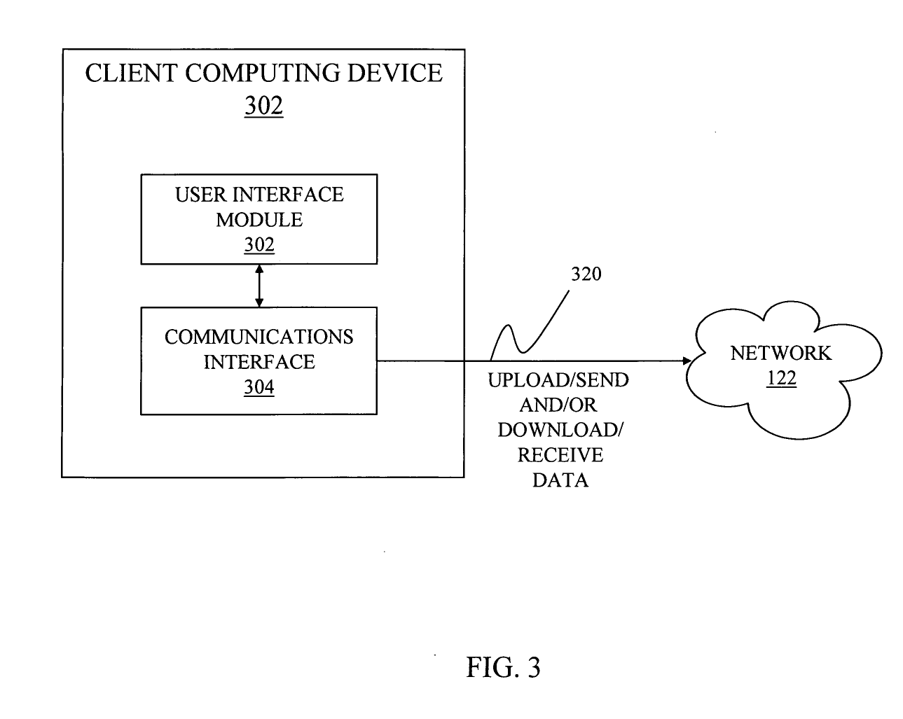

FIG. 3 is a block diagram of an embodiment of a client user or advertiser device 302, under an embodiment. The client computing device 302 includes a user interface module 302 and a communications interface 304. The user interface module 302 handles user presentation, which may be visual or auditory, or even both. For example, a user may enter search requests via stand-alone window programs or web pages within a web browser and enter commands via voice-commands, dual tone multi-frequency signals (DTMF), keyboard entries, touch-screen entries, mouse clicks, and the like. In an embodiment, the user interface 302 is a web browser presenting pages and accepting input from users. Examples of web browsers include MICROSOFT™ INTERNET EXPLORER and Firefox from Mozilla. The communications interface 304 enables a client to communicate 320 with the SAA system in general and particularly to the information manager 102. Alternatively, the user interface module is a stand-alone presentation interface, outside of a web browser, that enables the user to interface with the SAA system. Such presentation interface may be written in various programming languages and may function as a stand-alone set of program instructions, e.g., a stand-alone software.

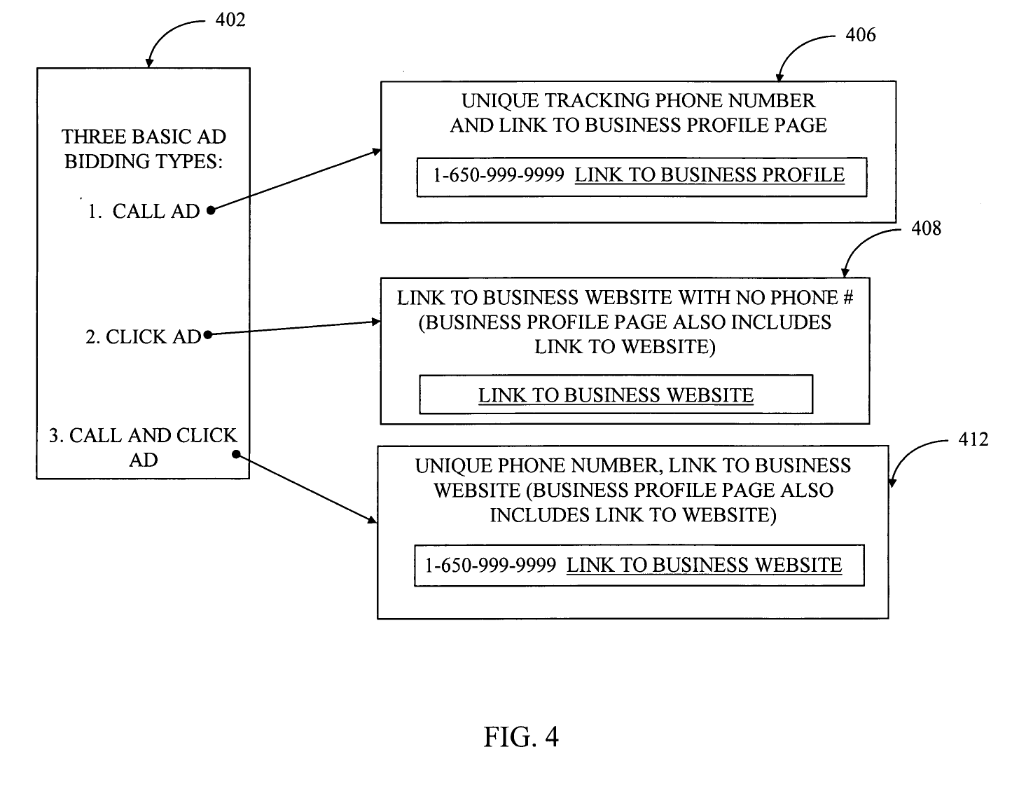

FIG. 4 is a schematic of ad types, under an embodiment. The SAA system 100 of the present invention, using the ad types, provides an efficient pricing mechanism for allocating advertising inventory and at the same time endeavors to maximize ad revenues for the operators or owners of the SAA system 100. In an embodiment, there are three ad types 402: a call ad type, a click ad type, and a call and click ad type. Each ad type includes a link to a business profile page as part of its ad listing.

A call ad type generally means that an advertiser is charged for each call received due to the ad, e.g., $5.00 for each call received by the advertiser. Other call conditions, however, may be implemented such as an advertiser pays a defined amount for a defined number of calls, e.g., $30.00 for ten calls. A call ad type in one embodiment 406 provides, in search results, an ad listing with a unique phone number and a hyperlink to a business profile page showing more information about the business or company, such as address, reviews, hours of operation, and other business or advertiser-related information.

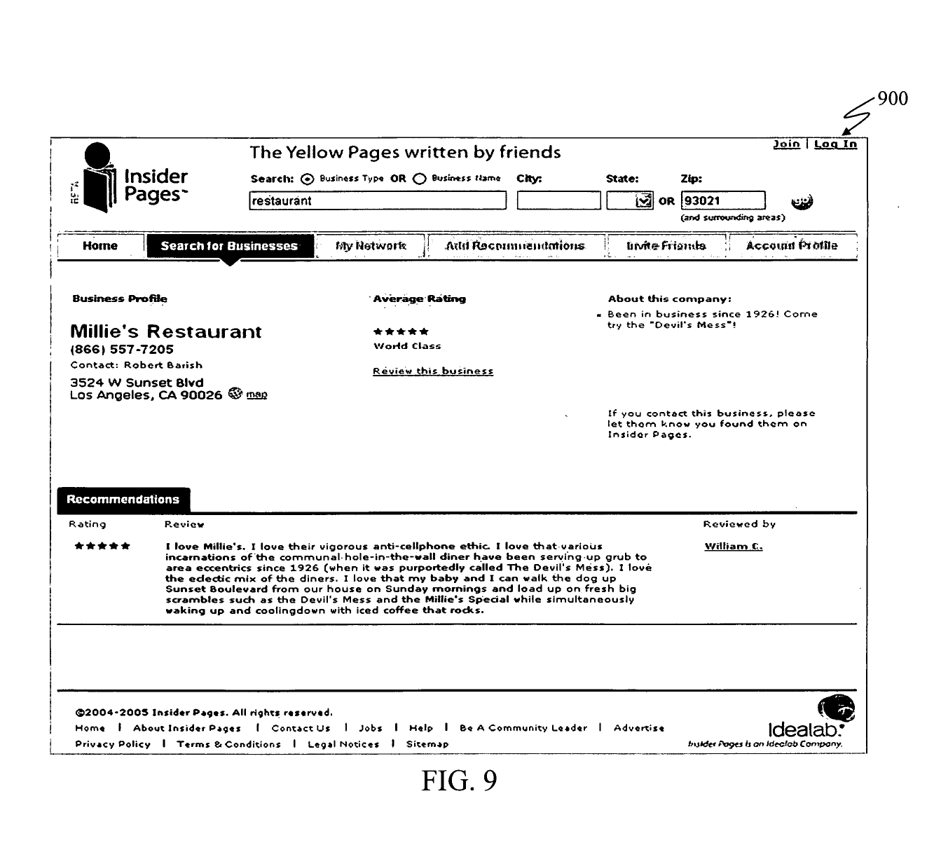

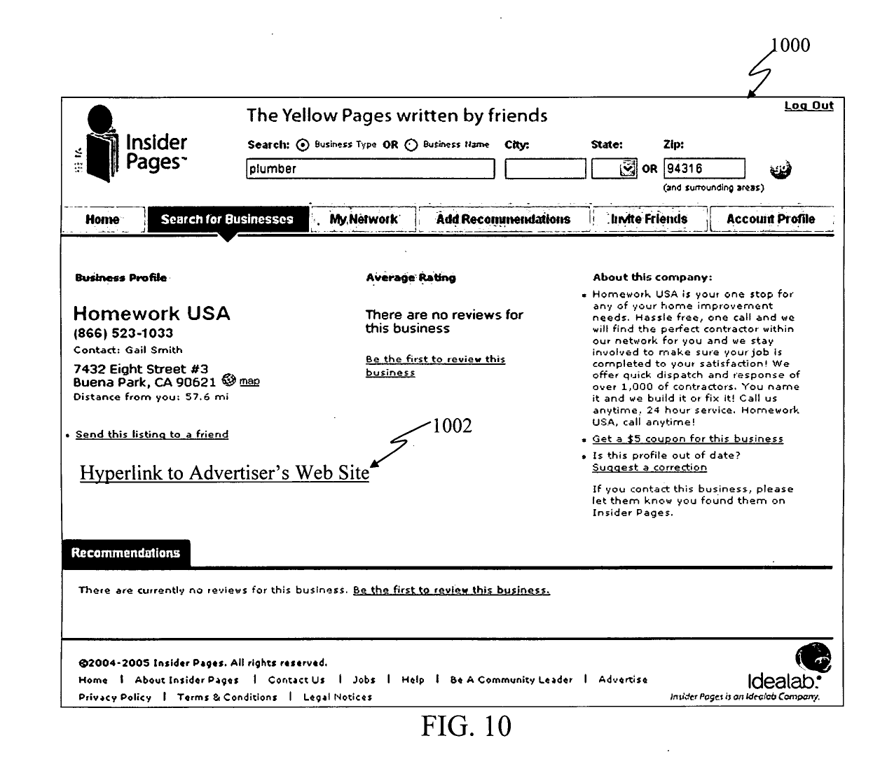

The click ad type, on the other hand, means that an advertiser is charged for each click received, e.g., $0.05 for each click. Other click conditions, however, may be implemented, for example, $0.50 for the first ten clicks and $0.40 for subsequent clicks. In one embodiment 408, the click ad type provides an ad listing with a hyperlink to the advertiser's designated web site, with no phone number displayed for example. The business profile page, however, also includes a link to the advertiser's designated website. The business profile page shows business or advertiser-related information and is exemplified in FIGS. 9 and 10.

A call and click ad type 412 means that ad advertiser is charged for both calls and clicks to the advertiser's web site—a combination of click ad type and call ad type. The two ad prices may be the same or different. In one embodiment, the call and click ad type 412 provides a unique phone number and a hyperlink to the advertiser's designated web site, or a unique phone number and a hyperlink to a business profile page that includes a hyperlink to the advertiser's designated web site. Variations on these embodiments, however, are expected and will be appreciated by those of ordinary skill in the art—for example, toll-free phone numbers may be used.

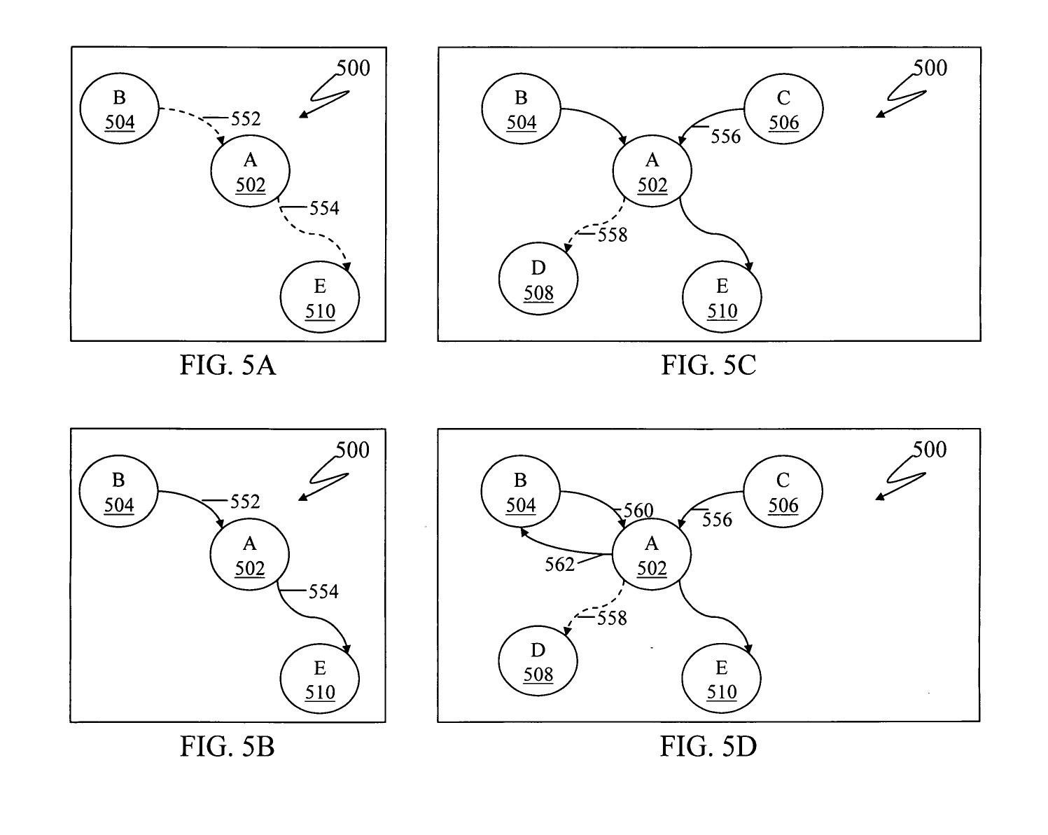

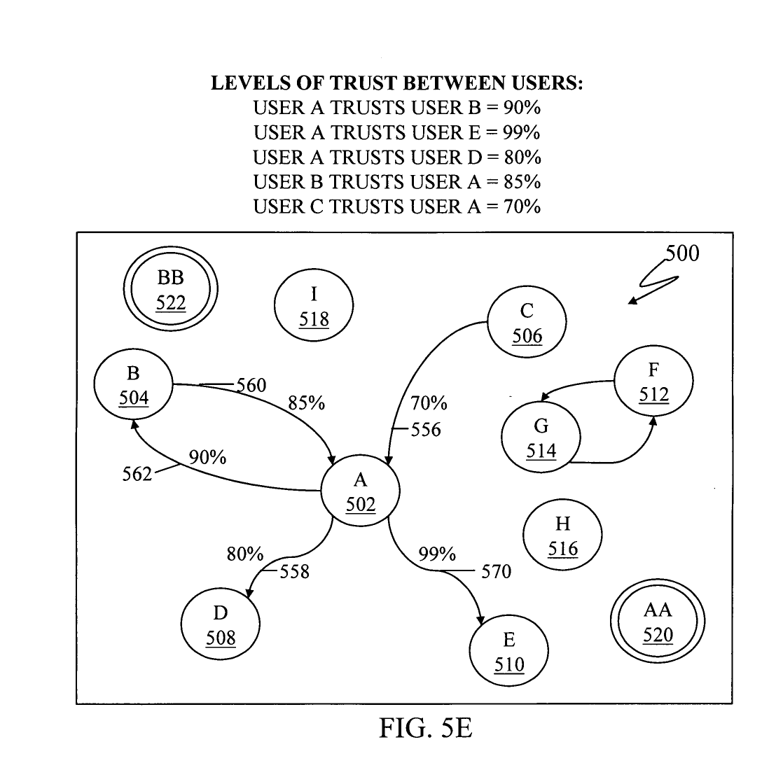

FIGS. 5A-5E show how a personal contact network according to an example embodiment of may be created incorporating the advertising features, under an embodiment. In particular, FIG. 5E is a graphical illustration of a user network 500 comprising a plurality of users 502, 504, 506, 508, 510, 512, 514, 516, 518, 520, 522. Users A, B, C, D, E, F, G, H, I are registered users while Users AA 520 and BB 522 are anonymous users of the SAA system. Users AA and BB are anonymous because they have not registered, such as by providing user information, e.g., user name and password and/or email address. Anonymous users may also participate in the features of the present invention, such as by posting search requests and providing anonymous reviews.

In this example network, a contact connection affinity network is defined within the SAA system 100. A contact connection affinity network generally defines the relationships between users, such as whether they are immediate or direct friends or are friends of friends. Users thus in one variation are able to see reviews of friends or reviews of friends of friends. In one embodiment of the invention, the user network only contains a contact connection affinity network type—meaning the users may be interrelated directly or indirectly by indicating those users of whom they are acquainted.

It is possible, however, that a registered user, e.g., Users H 516 and I 518, does not have any relationship with any other user. Furthermore, the network 500 may be disjointed such that pockets of subnetworks exist, e.g., subnetwork created by Users A 502, B 504, C 506, D 508, and E 510 and another subnetwork created by Users F 512 and G 514. In this example embodiment, a relationship or affinity with another user is only established when an invitation to join an affinity network is accepted. In another embodiment, not shown, acceptance of an invitation is not necessary to establish a relationship.

Each user is graphically shown as a node 502, 504, 506, 508, 510, 512, 516, 518, 520, 522 with an accepted relationship shown as a solid line between two users and an unaccepted relationship shown as a dashed line. The origin of a line indicates the inviting user and where the line ends with an arrow shows the invitee.

Referring to FIG. 5A, User B 504 invites User A 502 to establish a relationship; User A, however, has not accepted the invitation, as shown by the dashed line 552. User A 502 has also invited User E 510, but User E 510 has not accepted the invitation. In this example embodiment, the users have not established a relationship with each other. Other embodiments, however, do not require invitations and acceptances to establish relationships.

FIG. 5B is similar to FIG. 5A but illustrating the two accepted relationships as shown by the solid lines 552, 554. In this embodiment, the relationships between User B 504 and User A 502, and between User A and User E 510 have been established. User A is one connection away from User B, while User E is one connection away from User A. Users A and B are directly connected, similar to Users A and E. User B 504, however, is indirectly connected to User E 510, in this case, two connections away from user E 510. The connection number or value may be obtained by adding the number of connections between the two users—between Users B 504 and A 502, one connection, and between Users A 502 and E 510, one connection, for a total of two connections.

Generally, users invite other users to become part of their personal contact network. In this example embodiment, this is based on whether a user knows another user, meaning User B 504 invited User A because User B knows User A, and User A 502 invited User E 510 because User A knows User E. User B 504 knows User E 510 indirectly via User A 502, meaning User E is a friend of a friend, meaning a friend of User A.

FIG. 5C shows two more users being added to the network—Users C 506 and D 508. In this example, User C 506 issued an invitation to User A 502, which was accepted as shown 556. User A has also issued an unaccepted invitation to User D 508, shown by the dashed line 558. User C 506 is one connection away from User A 502, while User C 506 is two connections away from User D 508, User E 510, and User B 504.

FIG. 5D is similar to FIG. 5C, but in this example case User A 502 has also issued an invitation to User B 504, which User B accepted, shown by the solid line 562. The relationship between Users A 502 (inviter) and B 504 (invitee) denoted herein by AB, and the relationship between Users B (inviter) and A (invitee), denoted by BA, may be the same or different, depending on system design.

In one embodiment of the invention, the relationship is not only defined by the number of connections but also by a weight such as those shown in FIG. 5E. The relationship or affinity weight, in another embodiment, is assigned a default value, for example, based on the number of connections. This value may be adjusted by the user and/or automatically by the SAA system 100. Attributes affecting relationship or affinity weight, for example, may include how much, for example, User A trusts User B, e.g., a numerical trust value, the similarity of user's ratings, and the geographical distance between two users.

In one embodiment, the relationship is based on a reputation measurement or rating. The reputation rating is intended to reflect how trustworthy or reliable users are and their recommendations. Optionally, this personal reputation rating or score is viewable by other users via the Web site. In another embodiment, each user is assigned a unique reputation rating with respect to each other. The reputation rating may be assigned or calculated using one or more of the following attributes, as well as other relevant attributes:
Number of users in the system;
Number of accepted friends;
Ratio of connection invitations sent versus connection invitations accepted (in one embodiment, a connection invitation is defined as one user asking to share information with another);
Number of validations, e.g., feedbacks to reviews.

FIG. 5E is similar to FIG. 5D but showing that User D 508 has accepted the relationship invitation, shown by the solid line 558. In this example contact connection affinity network of affiliates, User A 502 trusts User B's recommendations or User B 504 ninety percent (90%) of the time, User E's 510 recommendations ninety-nine percent (99%) of the time, and User D's 508 recommendations eighty percent (80%) of the time. On the other hand, User B 504 trusts User A 502 eighty-five percent (85%) of the time, while User C 506 trusts User A 502 seventy percent (70%) of the time. In this example embodiment, ninety-nine percent (99%) is the highest level of trust a user may bestow upon another user. In this example embodiment, the relationship is influenced by the number of connections between users and the weight—level of trust—between the users.

One skilled in the art will recognize that various ways to calculate relationship weight, including the attributes used, may be implemented within the SAA system. In this example embodiment, the relationship between Users A and B 562 (AB) is 90%, between Users B and A 460 (BA) is 85%, between Users A and D 558 (AD) is 80%, Users A and E 570 (AE) is 99%, and Users C and A 556 (CA) is 70%. In one example embodiment of the invention, the relationship weight between Users C 506 and D 508 is derived by obtaining an average, which is 75%. Thus, in one example embodiment, the relationship weight between Users C and D is 75%. Other mechanisms of calculating the relationship weight may also be implemented. In an embodiment, the relationship or affinity is represented as a real number.

Other types of relationships may be implemented in the personal network of the present invention. For example, a familial affinity network may be implemented where relationships are based on blood or marriage relationship, such as mother, father, sibling, and second cousins. Depending on the relationship, each respective weight may be different.

Using the above example personal network, the information manager of the present invention enables users to filter and search for businesses/entities within a geographic location. The search may also be filtered or sorted based on user relationships and other attributes, such as ratings, distance from initial location, and business name.

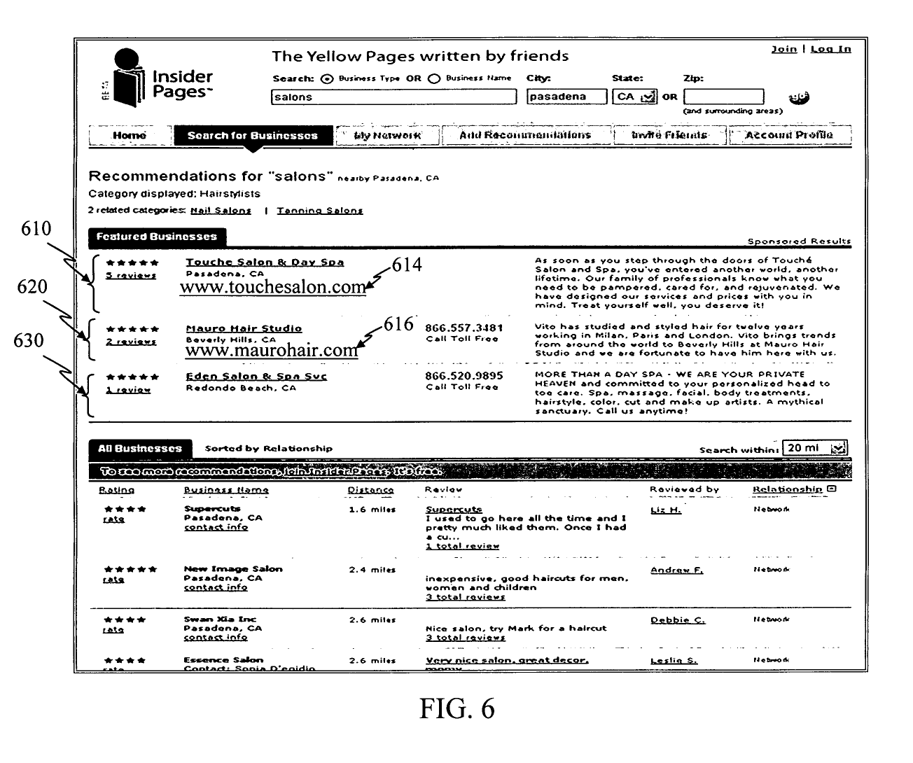

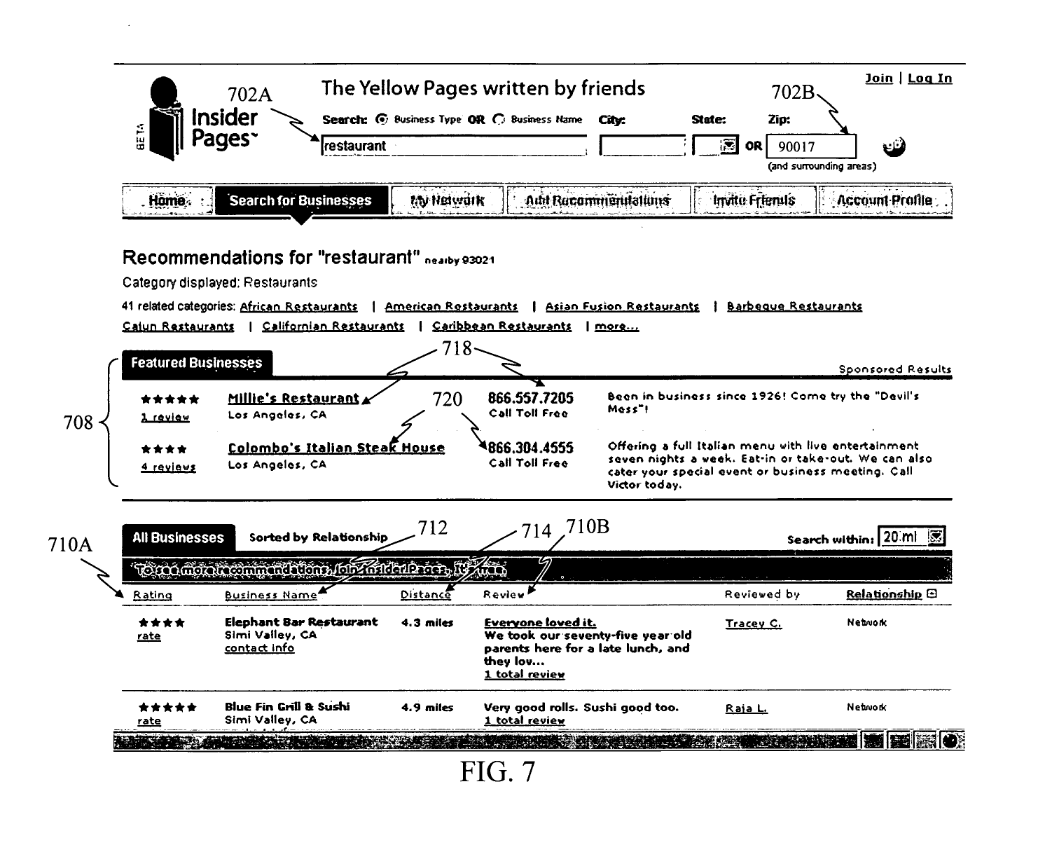

FIGS. 6-14 are example user interfaces, for example web pages, according to embodiments of the present invention. FIG. 6 shows the example embodiments of a click ad type 610, a call ad type 630, and a call and click ad type 620 listing, under an embodiment. The click ad type 610 and the call and click ad type 620 includes a hyperlink 614, 616 to the website designated by the advertiser. In FIG. 7, a user entered a search parameter consisting of “restaurant” 702A and “90017” 702B to search for restaurants within the zip code 90017. The search result is shown in this example web page, which includes the ad listings 708 of the present invention. This search result page is dynamically generated by the information manager 102, via a web server in conjunction with one or more modules 240 and/or one or more databases 210. The “Featured Businesses” area 708 shows paid advertisements/ad listings, particularly the call ad type. In an embodiment, a unique tracking phone number is designated within the SAA system that is associated with a unique advertiser or set of advertisers, e.g., 866-557-7205 is associated with Millie's Restaurant and 866-304-4555 is associated with Colombo's Italian Steak House. This way, the SAA system, particularly a telecommunications system, is able to identify the number of calls received by an advertiser, as well as other call-related information, e.g., date when called and duration of call. Other information may be included in the search result page, including, for example, reviews, including ratings, 710A and 710B, business name 712, and approximate distance from the initial target location 714, in this case from zip code 90017.

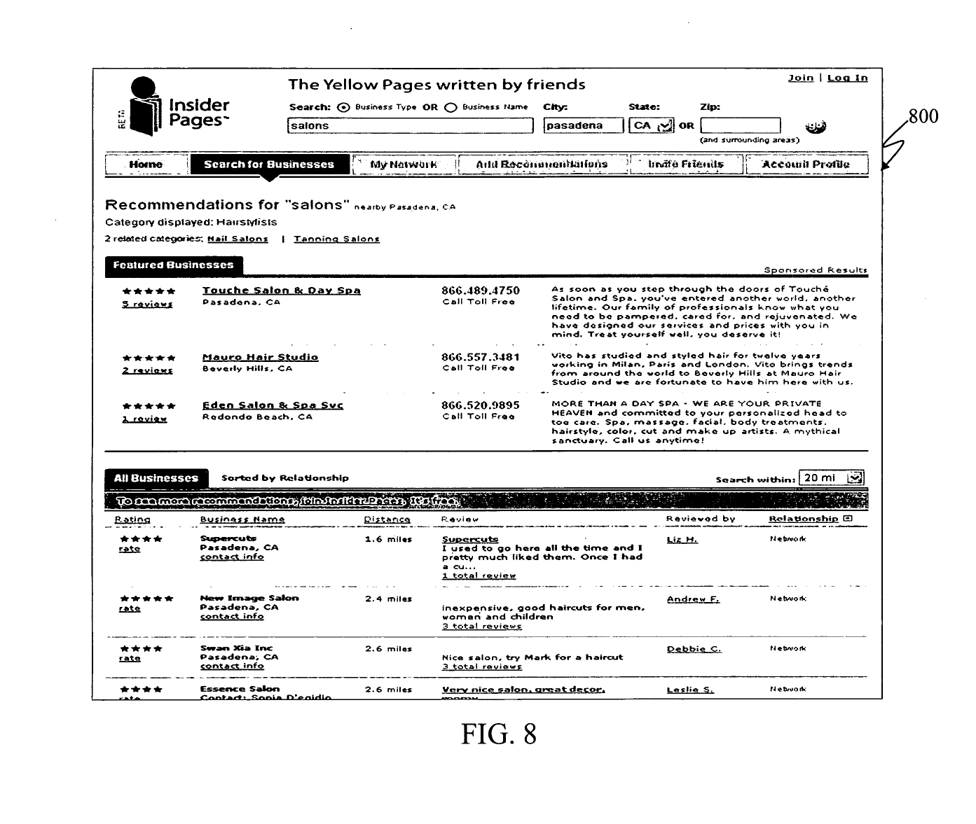

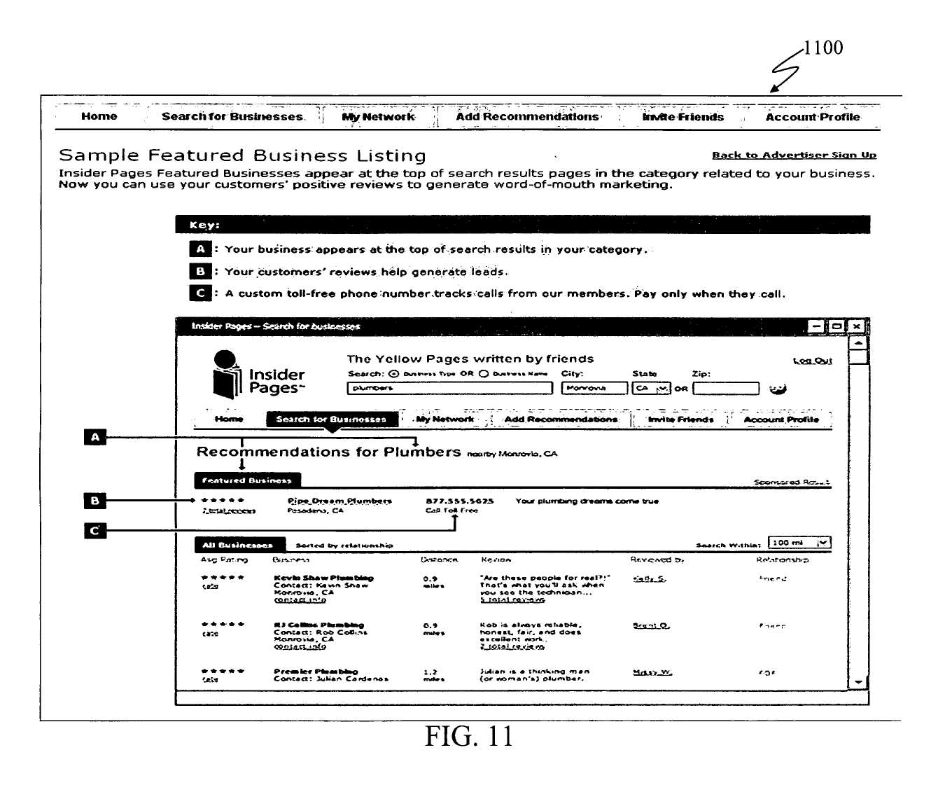

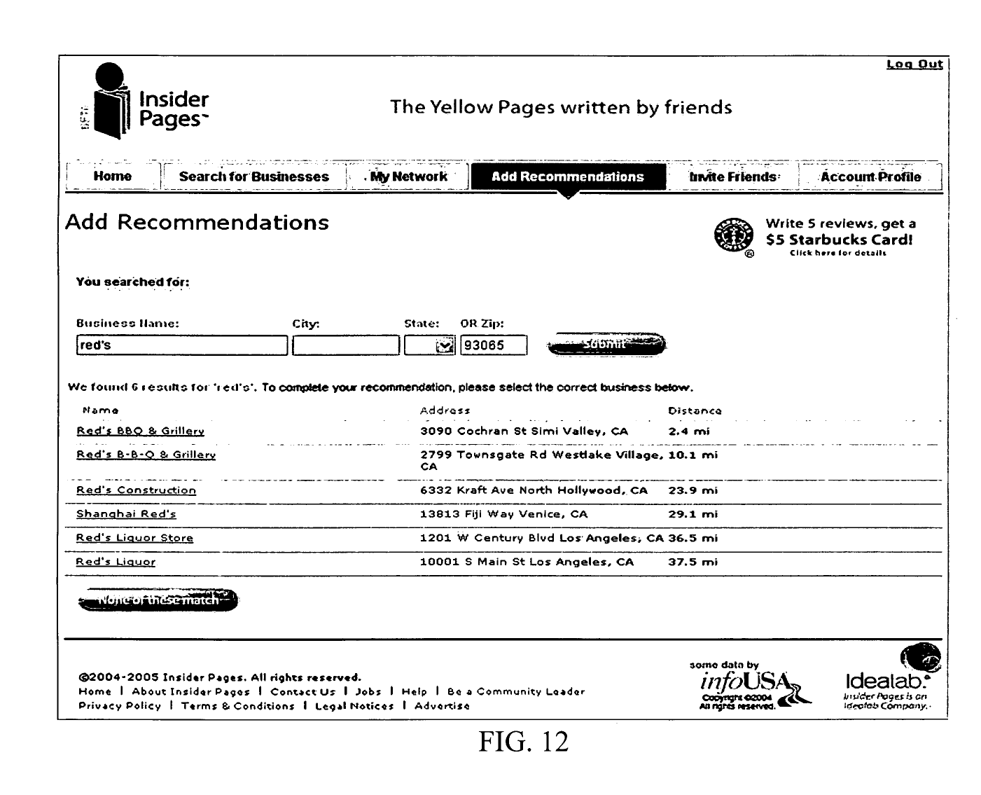

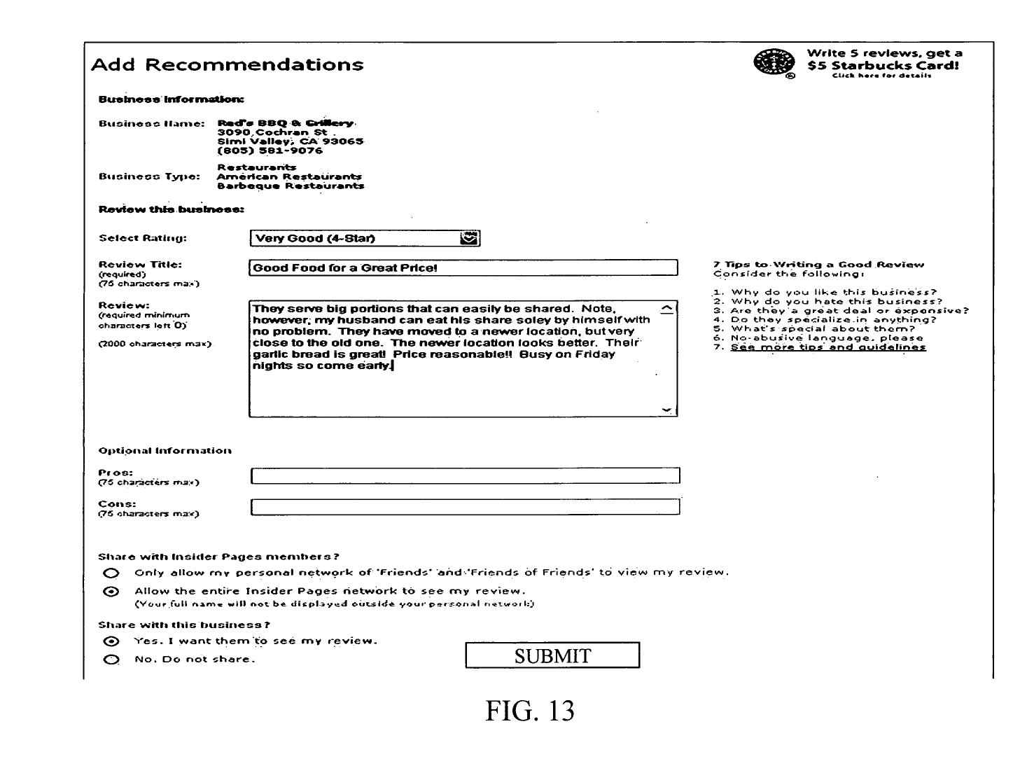

FIG. 8 is another example of a search result page 800 showing paid ad listings in the “Featured Businesses” section, under an embodiment. FIG. 9 is an example business profile page 900, displayed when the “Millie's Restaurant” hyperlink 718 (FIG. 7) is clicked, under an embodiment. This exemplifies a call ad listing. FIG. 10 is another example business profile page 1000, but which includes a hyperlink to the advertiser's web site 1002, under an embodiment. This user interface exemplifies an example business profile page of a call and click ad type. When a user clicks on the hyperlink 1002, the advertiser is charged, for example, for each click. The unique phone number for a user to call is also presented. FIG. 11 is an example web page 1100 shown to potential advertisers, showing some features, under an embodiment. FIG. 12 is an example page enabling a user to enter a search parameter so that a user may post a review, under an embodiment. FIG. 13 is an example page enabling a user to post a review within the SAA system, under an embodiment.

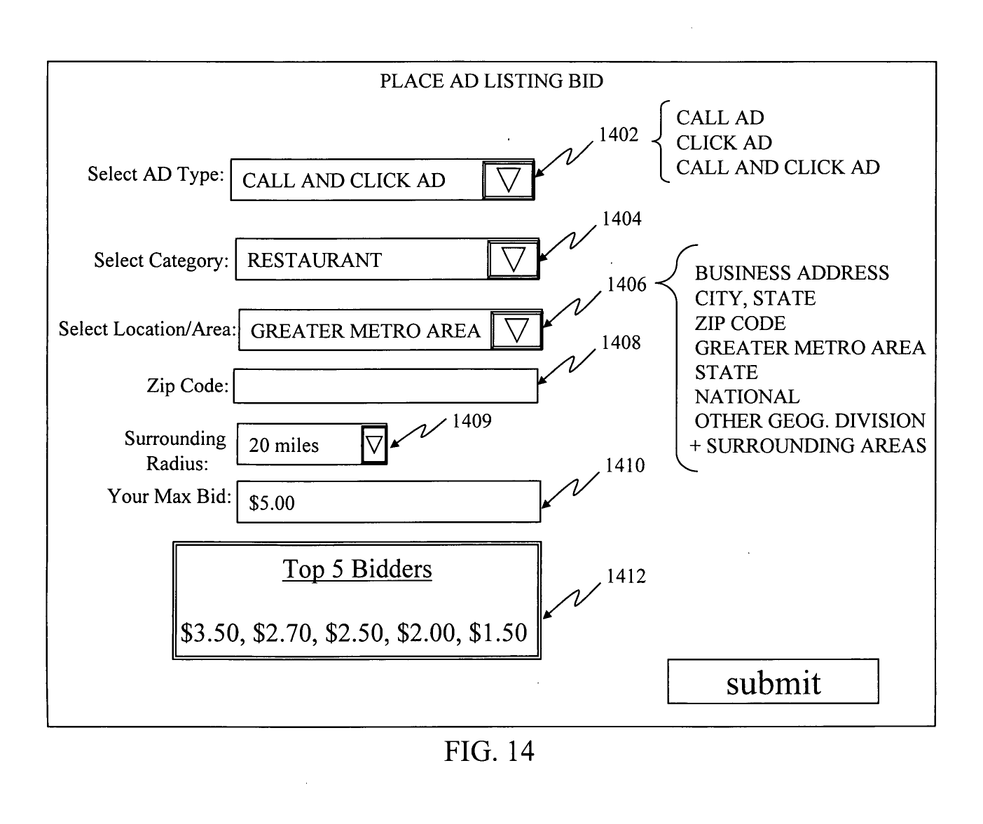

FIG. 14 is an example user interface, for example a web page, enabling an advertiser to place a bid for an ad listing, under an embodiment. In another embodiment, such ad listing bid may be placed over the phone via a sales representative (telesales), who interviews the advertiser advertiser and enters the ad listing bid of the advertiser via such an example user interface. Typically, there is a higher cost associated with telesales bidding, because of higher acquisition and service costs. To compensate for the higher telesales bidding cost, in one embodiment, the minimum bid is increased by a certain factor or value, if such bid is placed over the phone. In another embodiment, long-term telesales advertisers are charged a premium, e.g. a market price premium by adding ten percent more to the floor prices or increasing the bids of top bidders by ten percent. In another embodiment, advertisers are charged a “one-time management fee,” e.g., $50 to $100.00, or a “per call management fee,” e.g., $2.00, to assist telesales advertisers with bidding. This fee includes monitoring of the advertiser's ad placement and performance, and calling the advertiser when higher bids are required to stay in rotation or be placed in an ad. The sales representatives also encourage phone advertisers to use the online advertisement account management feature of the present invention, by providing the advertisers incentives to go online rather than via phone.

The SAA system 100 of the present invention is tailored to local businesses, considering that users are able to post reviews of local business as well as search for businesses local to a specified target area or location. In an embodiment, an advertiser specifies the ad type 1402, the category 1404, the target location 1406, which may include other information, such as zip code 1408, and the maximum bid 1410. In an embodiment, the ad listing is based on a category and zip code combination, and thus an advertiser is bidding for ad placement or listing based on that information. The advertiser, in order to facilitate advertising, is provided several options in specifying the geographic area 1406. Thus, an advertiser does not need to rely on zip codes but is able to specify a geographic area to target ad listings. Regardless of how the target location, including additional area, if any, is defined by a user, the information manager breaks such target location to the corresponding one or more target zip codes. Thus, it is possible that some advertisers are unaware that they are bidding on more than one zip code. Thus, an advertiser in Inglewood, Calif., for example, may experience higher competitor bid prices because its area to place an ad may encompass Beverly Hills zip code advertisers who are willing to pay higher bid prices to advertise.

The user of an embodiment is able to specify a target location 1406, e.g., by providing the business address, the city and state, the zip code, the greater metro area, the state, the county, or any other area division. Optionally, the target location may be augmented by a predefined or user-defined additional area 1409, such as additional 20 miles radius from the business address or 10 miles radius from a target zip code. A database, for example, specifying the zip codes included in a greater metro area may be incorporated as part of the system. For example, the greater metro area of “Downtown New York” is associated with example zip codes 10001, 10027, 10044, 10116, and 10150. Databases containing geocoded information and other geographic information are available, for example, from INFOUSA™ www.infousa.com and AMACAI INFORMATION CORP. Software or program instructions and/or databases to map out zip codes, including mapping out and calculating additional map radius, are also currently available. These program instructions and/or databases, for example, are able to provide the zip code of defined areas, such as zip codes within the city of Ventura and zip codes with the city of Ventura plus additional 20 miles. One way to determine target location and distance is using a method disclosed in the attached patent application, which is herein fully incorporated by reference.

Based on the category and zip code combination, the ad bid purchase module 256 of the information manager searches the category/zip code database 228, and associated tables and/or databases, and retrieves the bids of top advertisers and presents such information 1412 to the advertiser. The number of top advertisers presented may depend, for example, on the available ad spots, e.g., in one embodiment, the number of available spots or ad inventory is ten (10) ad spots multiplied by the number of page impressions as a result of user searches. In one embodiment, each search result includes only ten ad spots. In another embodiment, the number of available ad spots may depend on a set of conditions and/or be variably defined within the SAA system.

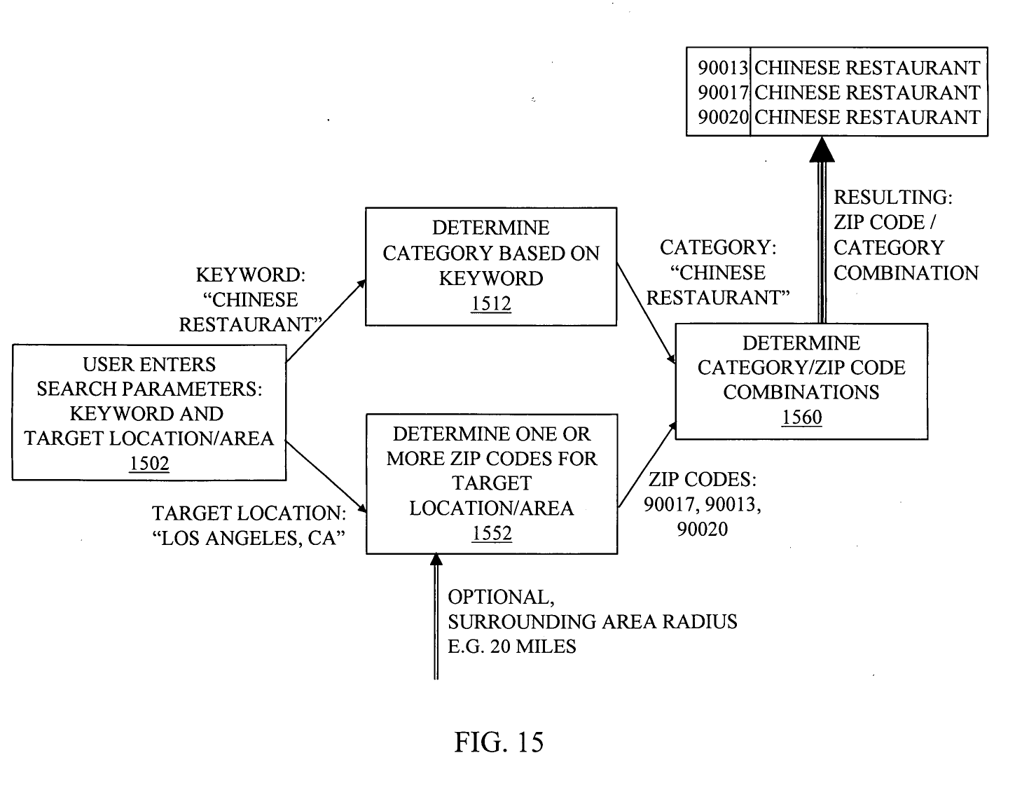

FIG. 15 is a schematic block diagram of how a user search is related to paid ad listings, under an embodiment. In the first block 1502, the user enters a search parameter, “Chinese restaurant” in the city of “Los Angeles” in the state of California. The search module 244 of the information manager generates the search result in response to that user search by obtaining the appropriate records from the appropriate databases 210. The search result page in response to the user's request thus includes listings of business that satisfy that search request.

Based on that search parameter, the ad bid purchase module 256 determines the one or more categories associated 1512 with the keyword “Chinese restaurant.” This keyword and category association may be contained in a database. In one embodiment, misspellings and related words are associated with categories, e.g., misspelled keyword “restaurnt” and “restaurante,” and other keywords such as “diner,” “eatery,” “food place,” and “dine-in” are all associated with the same category “restaurant.” In this example, the keyword “Chinese restaurant” is associated with the category “Chinese Restaurant.”

The target location provided by the user is then broken down by the ad bid purchase module 256 to the respective zip codes 1512, in this example, to example zip codes “90017, 90013, and 90020.” In another embodiment, surrounding areas are taken into consideration by expanding the user's target location by adding an extra area, such as defined by additional miles, zip codes, counties, and other regional identifiers. The category and the one or more zip codes are then combined to obtain category/zip code combinations or indexes. Based on this zip code and category combination 1560, in this example, “90013/Chinese Restaurant,” “90017/Chinese Restaurant,” “90020/Chinese Restaurant,” the ad bid purchase module retrieves, for example, five of the advertisers who have placed a bid on this category/zip code combination.

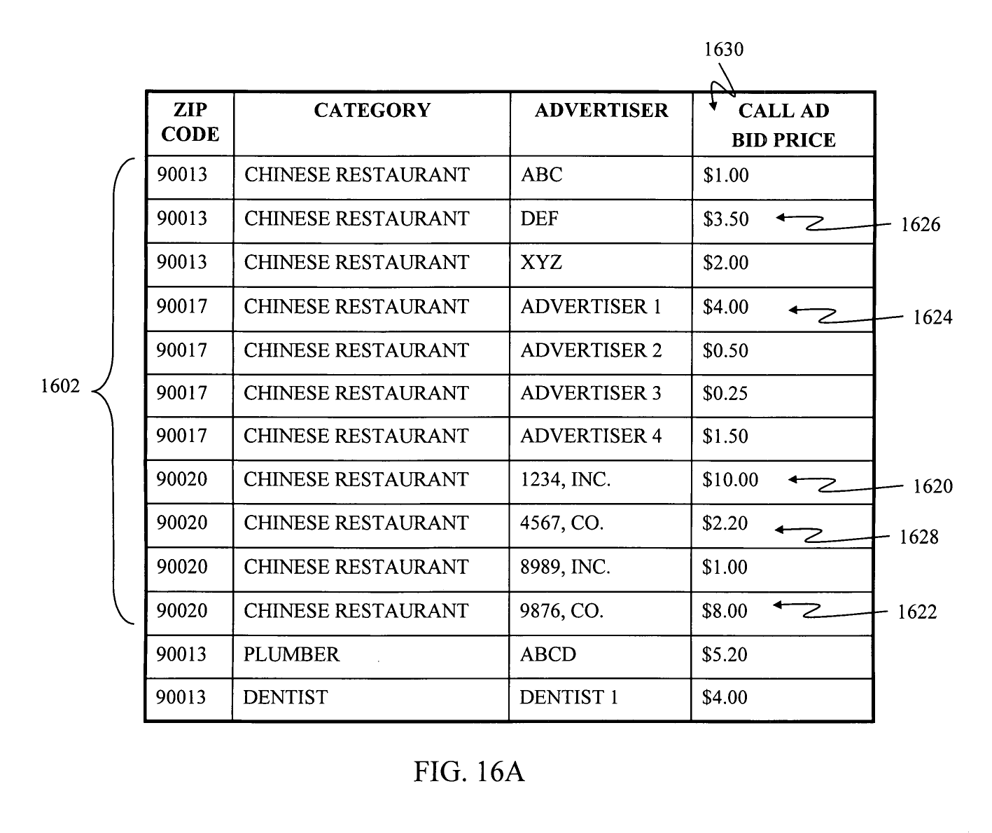

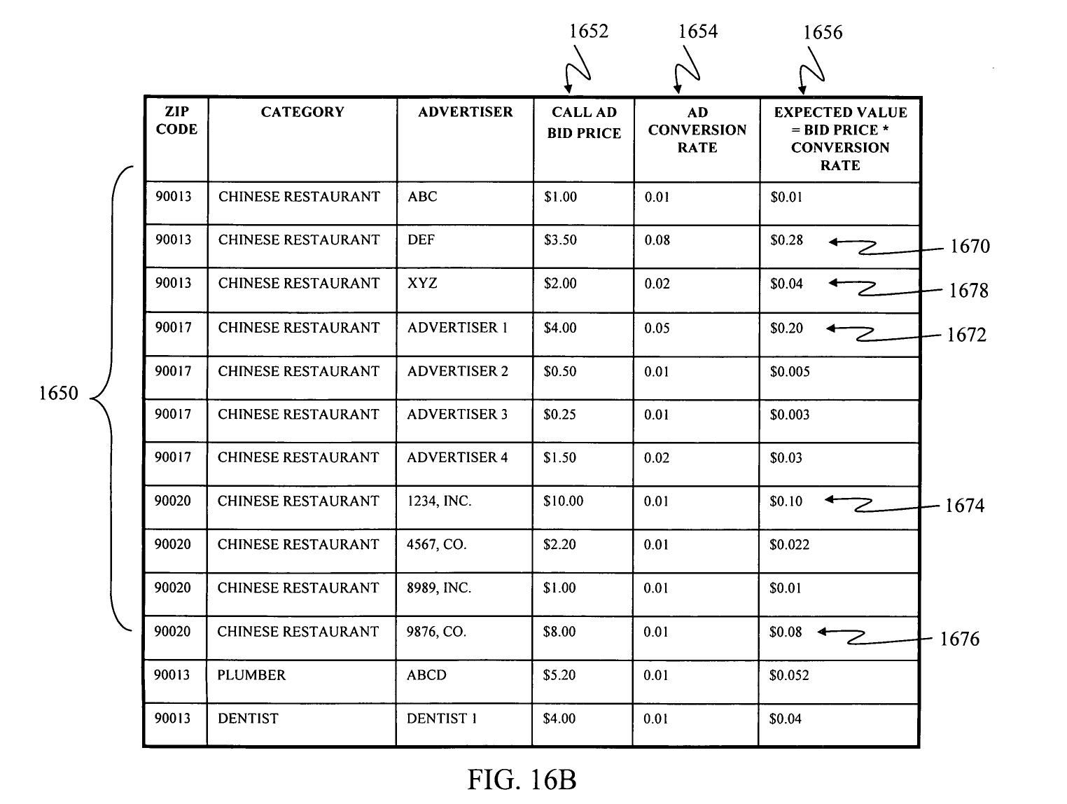

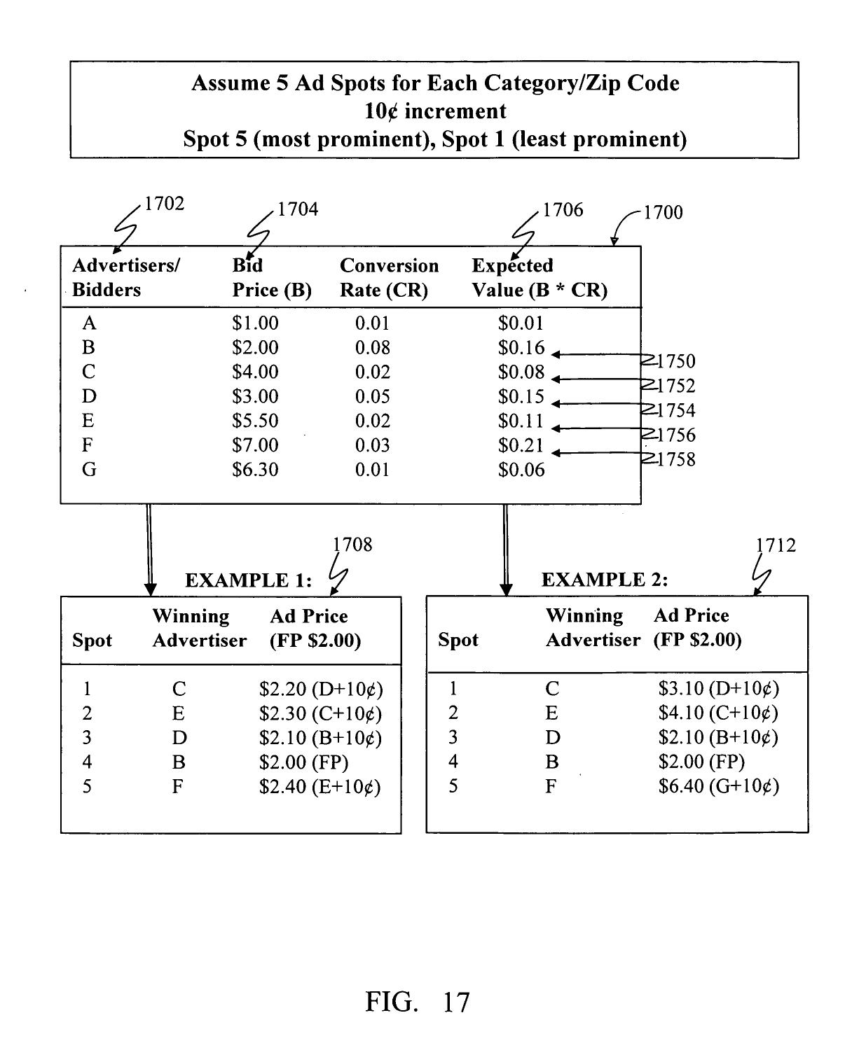

FIGS. 16A and FIG. 16B show display tables illustrating example portions of a database that contains ad bids, under an embodiment. In one embodiment, the ad bid purchase module retrieves the records of advertisers 1602 satisfying the zip code/category combination. These records are then sorted in descending bid price order 1630, and the appropriate advertisers, including their company information, are presented, for example, in the “Featured Section” area 708 of FIG. 7, in descending order limited by the number of available ad spots. Thus, if there are only three available ad spots, the ad listings for “1234, Inc.” 1620, “9876, Co.” 1622, and “Advertiser 1” 1624 are displayed in descending bid price order 1620, 1622, and 1624.

Based on the user's query, the search result page, for example, in FIG. 7, contains business listings satisfying the user's search—under the “All Businesses” section, as well as advertisers based on advertisers' bids—under the “Featured Businesses” section. Note, however, that not all advertisers who have placed a bid are shown in this example embodiment. In another embodiment, all advertisers are presented and ordered by descending bid price. If the advertiser is placing an ad listing for the above zip code (90013, 90017, 90020)/category (Chinese Restaurant) combination using, for example, the ad listing page in FIG. 14 and using the example database in FIG. 16A, the top five bidders area 1412 would show “$10.00, $8.00, $4.00, $3.50, and $2.20” 1620, 1622, 1624, 1626, 1628.

FIG. 16B shows another example display table, similar to FIG. 16A, illustrating an example portion of a database that contains ad bids. In this embodiment, the advertiser selection process seeks to maximize ad revenues for the operators or owners of the SAA system by including ad conversion rate 1654 as a factor in advertiser selection. Ad conversion rate 1654 is calculated by the SAA system as the (Number of Calls Received from the Ad) divided by (Number of Times the Ad is Presented). For example, a conversion rate of 0.08 for a call ad type indicates that the ad has received a call 8% of the times it has been displayed. Another way of explaining it, let us assume that a call ad type listing, for example, for “ABC Co.,” has been displayed one hundred (100) times in the “Featured Businesses” section in response to user requests. Users have called the unique phone number displayed for “ABC Co.” eight times out of the one hundred times it has been presented to users. This means that there is a conversion rate of 8% (8/100). The conversion rate for a click ad type is generally obtained by determining the number of clicks received from the ad divided by the number of times the ad is presented to the users. For example, a conversion rate of 0.10 for a click ad type indicates that the ad listing has received a “clickthrough” 10% of the times the ad listing has been displayed.

The ad conversion rate 1654 is multiplied by bid price 1652 to obtain the “expected value” 1656 for the ad. The ad bid purchase module retrieves the records of advertisers 1650 satisfying the zip code/category combination. These records are then sorted in descending expected value order 1656, and the appropriate advertisers, including their company information, are presented, for example, in the “Featured Businesses” area 708 of FIG. 7, in descending order of expected value limited by the number of available ad spots. Thus, if there are only three available ad spots, the ad listings for “DEF” 1670, “Advertiser 1” 1672, and “1234, Inc.” 1674 are displayed in descending expected value order 1670, 1672, and 1674.

Based on the user's query, the search result page, for example, in FIG. 7, contains business listings satisfying the user's search—under the “All Businesses” section, as well as advertisers based on advertisers' expected values—under the “Featured Businesses” section. Note, however, that not all advertisers who have placed a bid are shown in this example embodiment. In another embodiment, all advertisers are presented ordered by descending expected value.

In an embodiment, the bidding or auction pricing solution of the present invention has a market bid price set by the advertisers, both online and through phone sales representatives. This market bid pricing is based on a dynamic second price auction feature, described further below, with no ad placement guarantees. Advertisers are informed that their ad placement and expected leads from such ad placement will vary based on market competition.

FIG. 17 shows example display table embodiments of the dynamic second price auction feature, under an embodiment. In this example, there is a constraint of only five available ad spots or five ad inventory spots, with a minimum bid increment of ten cents (10¢), and with spot five (Spot 5) being the most prominent/top bidder and spot one (Spot 1) being the least prominent. Spot 5, for example, may be the first listing on the “Featured Businesses” section shown in FIG. 7, Spot 4 being the second listing, and so on and so forth, and Spot 1 being the last listing in this section 708. Other variations of how such ad listings are presented based on the bid amount may be implemented, such as the top bidder gets a listing that is bold or presented with a larger font size, an image is added to such ad listing, and the like.

The first table 1700 contains an example list of bidders 1702 A, B, C, D, E, F, and G and their corresponding bids 1704, ad conversion rates 1710, and expected values 1706. Considering that there are seven bidders/advertisers and there are only five ad spots, only five advertisers/bidders are able to obtain ad spots, for example advertisers C 1752, E 1756, D 1754, B 1750, F 1758 (bidders with top five expected values). These successful advertisers are able to have their ad listings displayed in the “Featured Businesses” section. The format of the ad listing in general depends on the ad type as shown in FIG. 4 and in FIG. 7, for example. Advertiser C 1752 has the lowest expected value, $0.08, and obtains the least prominent available Spot 1, while Advertiser F 1758 has the highest expected value, $0.21, and obtains the most prominent available Spot 5.

Example 1, bottom-left table 1708, shows an embodiment of the dynamic second price auction. In this example, the floor or market-entry price is obtained from the set of five winning advertisers who are able to obtain ad spots based on their expected values, in this case, Bidders C 1752, E 1756, D 1754, B 1750, and F 1758. The least bid amount from this set is $2.00 from Bidder B, and Bidder B pays a floor price of $2.00 for each call and/or click, depending on the ad type. The appropriate 10¢ minimum increments are then added to the ad prices as shown. For example, Bidder D bid $3, which is the next highest bid in column 1704 after Bidder B, so Bidder D pays the floor price of $2.00+10¢=$2.10. Continuing this example, Bidder C bid $4, which is the next highest bid after Bidder D, so Bidder C pays the floor price of $2.00+10¢+10¢=$2.20, while Bidder E pays $2.30 and Bidder F pays $2.40 for each call and/or click, depending on the ad type. Example 2, bottom-right table 1712, shows an embodiment of a dynamic second price auction feature of the present invention. In this example, the floor or market-entry price is obtained from the set of five winning advertisers who are able to obtain ad spots based on their expected values, in this case, Bidders C, E, D, B, and F. The least bid amount from this set is $2.00 from Bidder B, and Bidder B pays a floor price of $2.00 for each call and/or click, depending on ad type. Each other winning advertiser generally pays an ad price equal to the bid price of the advertiser whose bid is immediately lower than that advertiser's bid plus the minimum increment. For example, Bidder D, whose bid is $3.00, pays an ad price of $2.10, which equals the next or immediately lower bid from $3.00, which is $2.00 from Bidder B, plus 10¢. Bidder C, whose bid is $4.00, pays an ad price of $3.10, which equals the next or immediately lower bid from $4.00, which is $3.00 from Bidder D, plus 10¢. Bidder E, whose bid is $5.50, pays an ad price of $4.10, which equals the next lower bid from $5.50, which is $4.00 from Bidder C, plus 10¢. Bidder F, whose bid is $7.00, pays an ad price of $6.40, which equals the next or immediately lower bid from $7.00, which is $6.30 from Bidder G, plus 10¢. In this embodiment, the bid price of Advertiser G is taken into consideration even when Advertiser G has no placement in the available ad spots. In another embodiment, the next or immediately lower bid price is only obtained from the set of winning bidders, for example, Bidder F instead of paying $6.40 pays $5.60, by using the next lower bid price from $7.00 from the set of winning bidders, in this case Bidder E's bid of $5.50, plus 10¢. Other variations may also be incorporated.

This figure is only an example showing five available ad spots and does not so limit the embodiments described herein. In one embodiment, however, mechanisms enabling all bidders to be displayed or at least a subset of bidders may be implemented. This may be done for example by a rotation mechanism wherein the first top, e.g., five, bidders or expected value winners are presented in the first user search result, the next top five bidders or expected value winners are then presented in the next search user result, and so on and so forth. Other mechanisms, for example, such as displaying the top five bidders or expected value winners for the first one hundred search results and the rest of the search results based on a rotation scheme of advertisers based on their bid price or expected value, may also be incorporated as part of the embodiment of the invention.

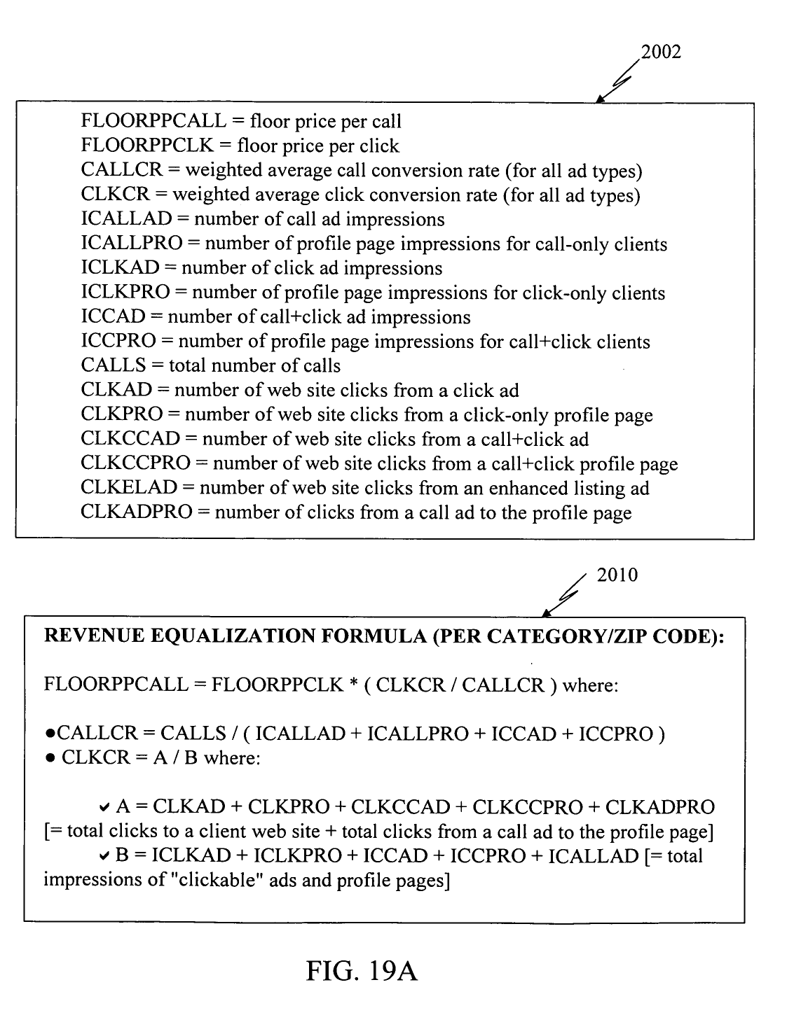

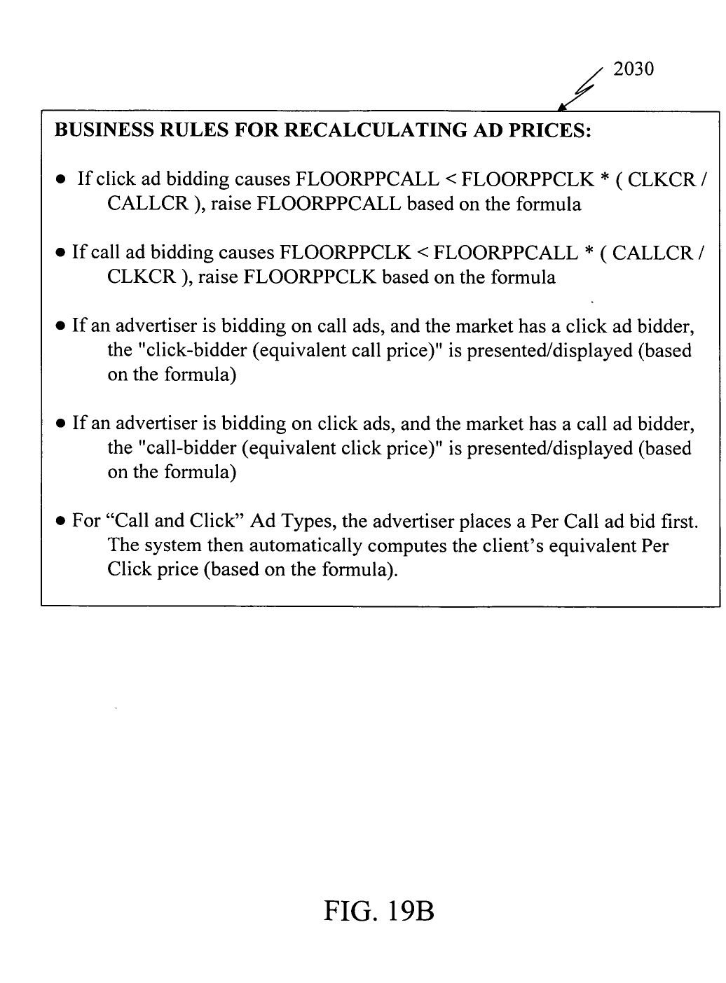

The floor prices of the present invention, however, may be modified based on certain conditions. In one embodiment, the floor price is modified by a price correlation formula as shown in FIGS. 19A and 19B.

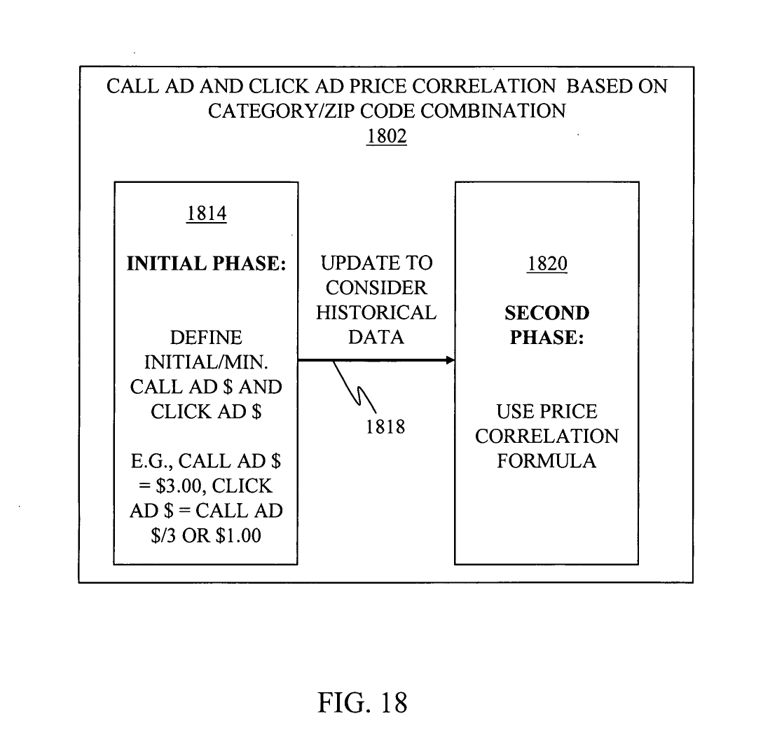

FIG. 18 shows a two-phase implementation of a scheme or process that equalizes the potential revenues and/or profits from the call ad and the click ad types, under an embodiment. Market floor prices for the call ad type and the click ad type are correlated, on a frequent and regular basis for example, to equalize the revenues and/or profits of each ad type. In one embodiment, revenue equalization is implemented by following two phases as shown. In the initial phase 1814, a default minimum bid value is defined for the call ad type for each category/zip code combination/index. A default minimum bid value is also defined for the click ad type, for example by a defined formula, such as a fixed ratio of the call ad type minimum bid value, e.g., minimum click ad type bid value=minimum call ad type bid value divided by 3. This minimum bid value is the initial floor for each category/zip code combination. As bidding occurs, the floor is updated to reflect market bidding increases or decreases 1818. Considering that there is a likely low level of competition in micro markets, i.e., local markets, bid prices and floor prices will generally not vary much in the initial phase thereby providing a low need for advertisers to be frequently actively participating in ad auction bidding or ad maintenance.

After a certain condition is met, when sufficient—e.g., statistically sufficient sample for a desired uncertainty level—historical data are gathered, the second phase may be initiated. This means that historical data captured from, for example, ad leads, traffic, search requests, and user patterns, e.g., conversion rate, click-through rate, call rate, number of ad impressions, etc., are used to more accurately and dynamically change the pricing, particularly, the floor prices, for each category/zip code combination to equalize revenues from the various ad types. An example price correlation formula, for example, as shown in FIGS. 19A and 19B is used. Thus the floor price of the dynamic second price auction feature of the present invention is updated on a regular basis, for example by a price correlation formula to maximize revenues for the operators of the SAA system.

FIGS. 19A and 19B show an example price correlation formula, used in accordance with an embodiment. For each category/zip code combination, the market floor prices for the call ad type and the click ad type are frequently correlated to equalize the revenues and/or profits of each combination. For example, one way to implement such feature is to ensure that the floor price of the click ad type equals the floor price of the call ad type divided by three (call ad type floor price/3), if the call ad type generates three times more revenue than the click ad type. A set of program instructions may be run, on a periodic basis, to check if the floor price has to be adjusted accordingly. FIG. 19B lists example business rules that may trigger updates to the floor prices based on the example correlation formula.

Outlined below is a general course of events for ad bidders:
1. Minimum and market prices for Pay Per Call/call ad type and Pay Per Click/click ad type are made available by business category and zip code. This set of information is stored in an RDBMS.
2. A radius is applied to a target location, e.g., based on the business location/address or target zip code. Advertisers may also opt to target a greater metro area, state or the entire U.S. instead of a radius from their business.
   1. The system translates the target location, including any radius, into corresponding zip codes. (Most advertisers bid in more than one zip code, but they are usually not aware of this mechanism.)
3. Prior to placing a bid, the advertiser chooses an ad type (Call Ad, Click Ad, or Call and Click Ad), business categories, target location, and/or radius. A radius picklist is provided with a system-defined default minimum per category, e.g., hair salon=10 miles minimum radius and contractor=20 miles minimum radius.
4. After selecting an ad type, business categories, target location, and/or radius, the advertiser is presented with the following information:
   1. For a category/zip code with no advertisers, the system minimum is displayed. Note, however, that this is based on looking at the various category/zip code combinations applicable to the user-provided target location, including radius, if any.
   2. For a category/zip code with advertisers, the names and bids of competitors are presented. Note, however, that this is based on looking at all the various category/zip combinations applicable to that target location, including radius, provided by the advertiser/bidder.
      1. If the advertiser is bidding on a call ad type, and the market includes a click bidder (meaning an advertiser, same or another advertiser, has an active bid for a click ad type), the “click-bidder (equivalent call price)” is presented based on a price correlation formula exemplified in FIGS. 19A and 19B.
      2. If the advertiser is bidding on a click ad type, and the market includes a call bidder (meaning an advertiser, same or another advertiser, has an active bid for a call ad type), the “call-bidder (equivalent click price)” is presented based on a price correlation formula exemplified in FIGS. 19A and 19B.
5. For call and click ad types, the advertiser first places a bid for a call ad type. The system then automatically computes the advertiser's equivalent Per Click price or click ad price, for example based on a price correlation formula exemplified in FIGS. 19A and 19B.
6. Advertisers are instructed to bid the maximum amount they want to pay for a call or click. Their actual price will often be lower due to the dynamic 2^{nd} price auction, as shown in FIG. 17.

As described above, the ad auction pricing features of the present invention may be performed by an advertiser via an online auction bidding system or by calling sales representatives over the phone and placing a bid via these sales representatives. Placing the bid using sales representatives, however, may entail constant advertiser updates, particularly when the category/zip combination for that ad is a hot market.

To accommodate advertisers who to want a fixed price per call and/or click for a set time period, without the need to monitor and adjust bids, in an embodiment, advertisers are provided with the option to participate in a fixed-price ad system. The fixed-price ad system in general enables an advertiser to purchase ads for a fixed price per call and/or click for a fixed period of time, and depending on the when the ad order is placed, be allocated a certain number or portion of ad listing presentations. In this embodiment, an advertiser is offered a fixed price, for example, per call and/or click, for a set time period. This fixed price has a premium as compared to prices paid by auction bidders. In one embodiment, the fixed price is equal to the maximum auction bid price plus a variable percentage, such as 10%, which may be dynamically and variably changed based on market conditions or category/zip code combinations, for example. The fixed-price advertisers are also offered a spending cap, for example, a dollar cap for total ad cost per month. This dollar cap is generally based on ad inventory projections. For example, the advertiser is offered a $100.00 cap for total ad cost per month. In another embodiment, an advertiser is offered a number cap, such as a maximum number of calls and/or clickthroughs per month. For example, if the fixed price offered for a call ad is $10.00 with a $100.00 cap per month, the advertiser is allocated potentially 10 calls per month. The number of times the advertiser's ad listing is displayed in one embodiment is based on the ad conversion rate and/or the number of projected ad listing presentations to users. A cap is set so that the SAA system of the present invention is able to allocate appropriate ad inventory spots to fixed-price advertisers. In another embodiment, the advertiser is provided with several lock-in periods, e.g., 30 days, 90 days, or 180 days. This lock-in period provides advertisers a way to manage their advertising decisions and alerts the advertisers of their next renewal period. When a lock-in period ends, the renewal fixed price per call and/or click is set to the current maximum auction bid plus a premium variable. In general, if the renewal fixed price is too high, the sales representative may suggest auction bidding or offer an advertiser callback when the fixed price falls below a certain threshold.

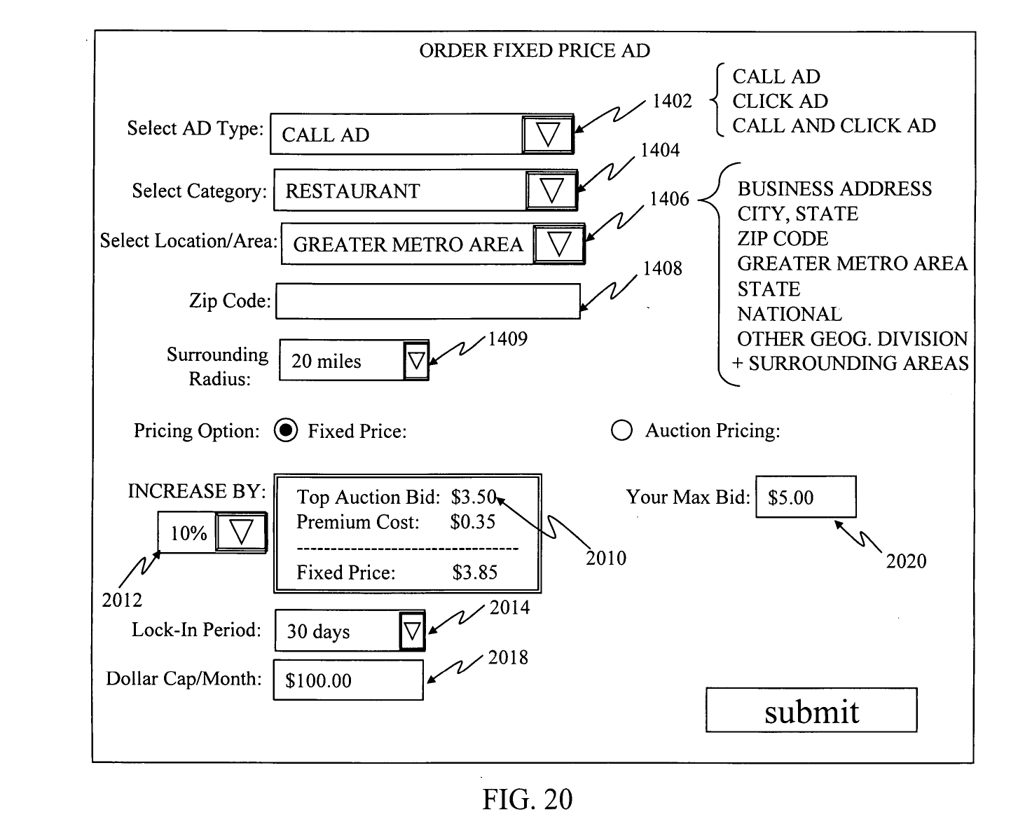

FIG. 20 is an example interface enabling sales representatives, for example, to enter fixed price orders or telesales auction bids on behalf of advertisers, under an embodiment. FIG. 20 is similar to FIG. 14 with some variations. In this example interface, an advertiser specifies the ad type, the category, the target location/area, and optionally the surrounding radius from the target area. The advertiser then chooses between two pricing options: Fixed Price or Auction Pricing. If the advertiser selects the Fixed Price option, the top auction bid price(s) 2010, optionally, also showing top fixed price(s), is presented. The premium variable or parameter 2012, such as percentage over the top bid price(s), may be set by the sales representative or may be system-defined. In one embodiment, the advertiser also specifies the lock-in period 2014. The lock-in period, in one embodiment, influences the premium variable 2012, for example, a lock-in period of 30 days and 60 days mean a 10% and 13% premium over the maximum auction bid price, respectively. The advertiser is also communicated a dollar cap amount 2018, for example, per month, based on ad inventory projections. In another embodiment, the advertiser can enter their desired dollar cap amount. If the advertiser selects the Auction Pricing option, the advertiser's maximum bid 2020 is entered into the system.

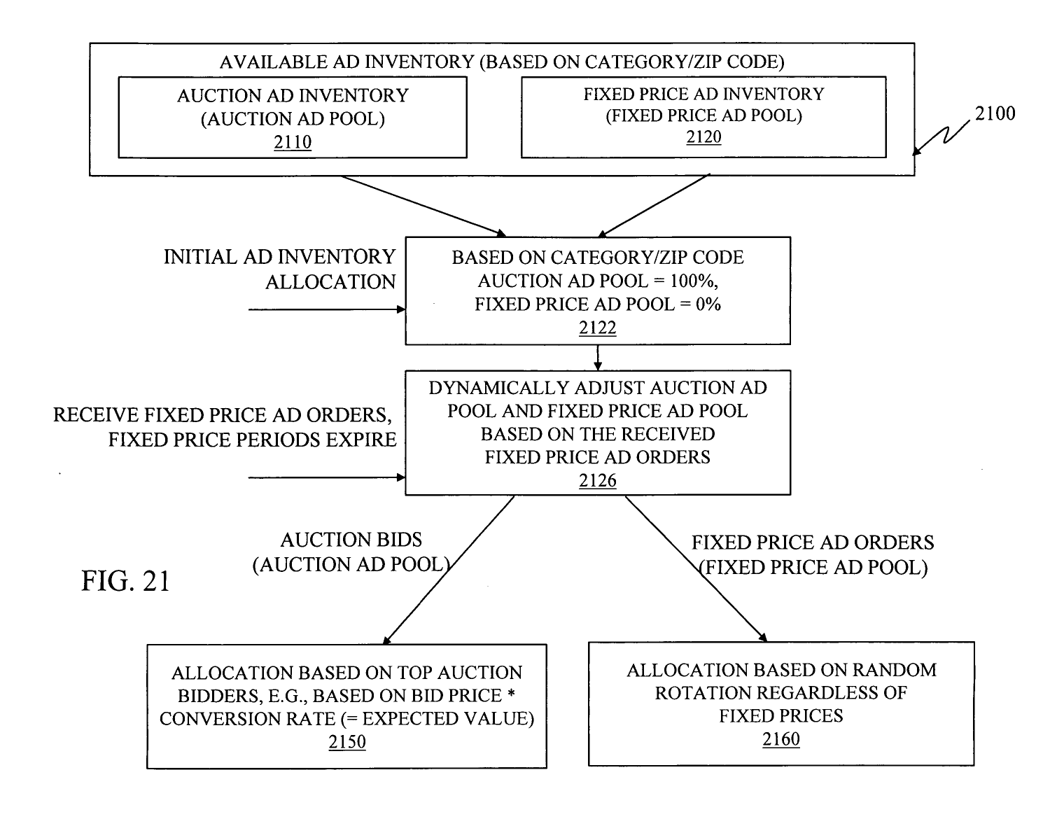

FIG. 21 shows a schematic block diagram of the available ad inventory 2100 of the present invention and how such ad inventory is allocated, under an embodiment. The available ad inventory 2100, based on category/zip code combinations, consists of the auction ad pool 2110 and the fixed-price ad pool 2120. Initially, the entire available ad inventory, based on category/zip code combinations, is entirely allocated to the auction ad pool (step 2122), that is only ad listings of winning auction advertisers/bidders are presented to searching users (see “Featured Business” section for example in FIG. 7). For example, if there are only five available ad spots, all the ad spots are allocated to ad listings for winning auction bidders. In general, as fixed-price ad orders are received and/or expire, the auction ad pool is adjusted to accommodate the fixed-price ads (step 2126). For example, appropriate inventory spots previously allocated to the auction ad pool are moved to the fixed price ad pool—e.g., out of the five available ad inventory spots, four ad spots are allocated for auction bidders, while one ad spot is allocated for fixed-price advertisers. In an embodiment, ad inventory for the auction pool is not mixed with ad inventory for the fixed price ad pool. For example, if users enter 5 searches for a particular category/zip code, the first 4 searches present ad listings from the auction pool to searching users (see “Featured Business” section for example in FIG. 7), and the 5th search presents ad listings from the fixed-price ad pool. The auction ad pool and the fixed price ad pool, based on category/zip code, are frequently or periodically adjusted to account for increases or decreases in the quantity of active (unexpired) fixed-price ads. In general, the ad pools are dynamically expanded or shrunk depending on the volume of fixed-price ad orders.

The ad listings are presented as part of search results based on the pool, i.e., whether the ad listing is to fill an auction ad pool or a fixed price ad pool. Ad listings allocated for auction ad pools are presented based on the highest expected value (step 2150), as described above, particularly in FIG. 17. Ad listings allocated for fixed price ad pools, in one embodiment, are presented based on a random rotation of all unexpired or active fixed-price advertisers for that particular category/zip code combination, regardless of the fixed-price value of each ad listing. Variations on the presentation logic for fixed-price ad listings are expected and will still be in the scope of the invention. For example, the fixed-price ad value, the lock-in period, and/or the cap may influence the rotation.

The advertising systems of an embodiment include a method for advertising. The method for advertising of an embodiment comprises receiving bid requests for advertisement (ad) placement. The bid requests of an embodiment include a bid amount and one or more of an ad type, a category, and a geographic area. The method for advertising of an embodiment comprises determining ad pricing for the ad placement using the bid requests in a dynamic price auction. The ad pricing of an embodiment includes one or more of a floor price and another ad price. The method for advertising of an embodiment comprises periodically modifying the ad pricing according to price correlation data among ads having different ad types. The method for advertising of an embodiment comprises placing one or more ads in electronic ad spots according to the ad pricing.

The method of an embodiment further comprises providing a listing for the ad slots, the listing based on one or more of the category and the geographic area.

The ad type of an embodiment includes one or more of a click ad type, a call ad type, and a call and click ad type.

Determining ad pricing for the ad placement using a dynamic second price auction of an embodiment comprises generating an expected value for each bid request. Determining ad pricing for the ad placement using a dynamic second price auction of an embodiment comprises selecting selected ads for ad placement according to the expected values, wherein the selected ads include at least one ad.

Selecting selected ads for ad placement of an embodiment according to the expected values comprises selecting a pre-specified number of ads having the highest expected values.

Determining ad pricing for the ad placement using a dynamic second price auction of an embodiment comprises one or more of determining the floor price to be a lowest bid amount among the selected ads, assigning the floor price to an ad corresponding to the lowest bid amount, and setting the other ad prices of each remaining selected ad relative to the floor price.

Setting the other ad prices of an embodiment comprises one or more of generating a first other ad price by adding a pre-specified monetary increment to the floor price, and assigning the first other ad price to a first ad of the selected ads, the first ad corresponding to a first incrementally higher bid amount relative to the lowest bid amount.

Setting the other ad prices of an embodiment comprises one or more of generating a second other ad price by adding the pre-specified monetary increment to the first other ad price, and assigning the second other ad price to a second ad of the selected ads, the second ad corresponding to a second incrementally higher bid amount relative to the first incrementally higher bid amount.

Setting the other ad prices of an embodiment comprises, for each selected ad other than the ad corresponding to the lowest bid, generating another ad price approximately equal to a sum of a pre-specified monetary increment plus a bid that is immediately lower than a bid of the selected ad.

Generating an expected value of an embodiment comprises one or more of determining an ad conversion rate for an ad by dividing a number of inquiries to the ad by a number of times the ad is presented to users, and multiplying the ad conversion rate by the respective bid amount of the ad. The number of inquiries of an embodiment includes one or more of number of clicks received form the ad and the number of calls received from the ad.

The method of an embodiment comprises assigning a prominence to selected ads according to the expected values.

Modifying the ad pricing of an embodiment according to price correlation data among ads having different ad types approximately equalizes potential revenues from different ad types.

Modifying the ad pricing of an embodiment comprises one or more of determining a minimum bid value for each ad type in each geographic area, and modifying the determined minimum bid values of each ad type in response to historical data of each ad type, wherein the historical data includes one or more of ad leads, traffic search requests, and user patterns that include one or more of conversion rate, click-through rate, call rate, and number of ad impressions.

Modifying the determined minimum bid value of an embodiment comprises one or more of determining one ad type having the highest revenue among the ad types, determining a factor by which revenue of the one ad type exceeds revenue of one other ad type, dividing the floor price of the other ad type by the factor to generate a modified floor price for the other ad type, and adjusting the floor price for the other ad type to equal the modified floor price.

The ads of an embodiment include fixed-price ads, and further comprising providing an option for fixed-price advertising for set time periods for a subset of advertisers based on the auction bid prices.

The method of an embodiment comprises allocating ad spots for ad placement among the bid requests and requests for the fixed-price advertising.

The method of an embodiment comprises presenting a search result in response to a user query, the search result including the one or more placed ads.

The advertising systems of an embodiment include a system comprising at least one advertising system coupled to a processor. The advertising system of an embodiment is configured to receive bid requests for advertisement (ad) placement. The bid requests of an embodiment include a bid amount and one or more of an ad type, a category, and a geographic area. The advertising system of an embodiment is configured to determine ad pricing for the ad placement using the bid requests in a dynamic price auction. The ad pricing of an embodiment includes one or more of a floor price and another ad price. The advertising system of an embodiment is configured to periodically modify the ad pricing according to price correlation data among ads having different ad types. The advertising system of an embodiment is configured to place one or more ads in electronic ad spots according to the ad pricing.

The ad type of an embodiment includes one or more of a click ad type, a call ad type, and a call and click ad type.

The system of an embodiment is configured to determine ad pricing for the ad placement using a dynamic second price auction by one or more of generating an expected value for each bid request, and selecting selected ads for ad placement according to the expected values, wherein the selected ads include at least one ad.

Configured to determine ad pricing for the ad placement using a dynamic second price auction of an embodiment comprises configured to one or more of determine the floor price to be a lowest bid amount among the selected ads, assign the floor price to an ad corresponding to the lowest bid amount, and set the other ad prices of each remaining selected ad relative to the floor price.

Configured to set the other ad prices of an embodiment comprises configured to generate at least one other ad price by adding a pre-specified monetary increment to one or more of the floor price and one other previously-determined other ad price.

Configured to set the other ad prices of an embodiment comprises, for each selected ad other than the ad corresponding to the lowest bid, configured to generate an other ad price approximately equal to a sum of a pre-specified monetary increment plus a bid that is immediately lower than a bid of the selected ad.

Configured to generate an expected value of an embodiment comprises configured to one or more of determine an ad conversion rate for an ad by dividing a number of inquiries to the ad by a number of times the ad is presented to users, wherein the number of inquiries includes one or more of number of clicks received form the ad and the number of calls received from the ad, and multiply the ad conversion rate by the respective bid amount of the ad.

The advertising system of an embodiment is configured to assign a prominence to the selected ads according to the expected values.

Configured to modify the ad pricing of an embodiment comprises configured to one or more of determine a minimum bid value for each ad type in each geographic area, and modify the determined minimum bid values of each ad type in response to historical data of each ad type, wherein the historical data includes one or more of ad leads, traffic search requests, and user patterns that include one or more of conversion rate, click-through rate, call rate, and number of ad impressions.

Configured to modify the determined minimum bid value of an embodiment comprises configured to one or more of determine one ad type having the highest revenue among the ad types, determine a factor by which revenue of the one ad type exceeds revenue of one other ad type, divide the floor price of the other ad type by the factor to generate a modified floor price for the other ad type, and adjust the floor price for the other ad type to equal the modified floor price.

The ads of an embodiment include fixed-price ads. The system of an embodiment is configured to provide an option for fixed-price advertising for set time periods for a subset of advertisers based on the auction bid prices.

The advertising systems of an embodiment include computer readable medium including executable instructions which, when executed in a processing system, manage advertising by receiving bid requests for advertisement (ad) placement, the bid requests including a bid amount and one or more of an ad type, a category, and a geographic area. Execution of the instructions of an embodiment determines ad pricing for the ad placement using the bid requests in a dynamic price auction. The ad pricing of an embodiment includes one or more of a floor price and another ad price. Execution of the instructions of an embodiment periodically modifies the ad pricing according to price correlation data among ads having different ad types. Execution of the instructions of an embodiment places one or more ads in electronic ad spots according to the ad pricing.

Although this invention has been disclosed in the context of certain embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

Unless otherwise indicated, the functions described herein are performed by programs or sets of program codes, including software, firmware, executable code or instructions running on or otherwise being executed by one or more general-purpose computers or processor-based systems. The computers or other processor-based systems may include one or more central processing units for executing program code, volatile memory, such as RAM for temporarily storing data and data structures during program execution, non-volatile memory, such as a hard disc drive or optical drive, for storing programs and data, including databases and other data stores, and a network interface for accessing an intranet and/or the Internet. However, the present invention may also be implemented using special purpose computers, wireless computers, state machines, and/or hardwired electronic circuits.

Throughout the following description, the term “Web site” is used to refer to a user-accessible network site that implements the basic World Wide Web standards for the coding and transmission of documents. These network sites may also be accessible by program modules executed in computing devices, such as computers, interactive television, interactive game devices, wireless web-enabled devices, and the like. The standards typically include a language such as the Hypertext Markup Language (HTML) and a transfer protocol such as the Hypertext Transfer Protocol (HTTP). Other protocols may also be used such as file transfer protocol (FTP), wireless application protocol (WAP) and other languages such as the extensible markup language (XML) and wireless markup language (WML). It should be understood that the term “site” is not intended to imply a single geographic location, as a Web or other network site can, for example, include multiple geographically-distributed computer systems that are appropriately linked and/or clustered together. Furthermore, while the following description explains by example an embodiment utilizing the Internet and related protocols, other networks, whether wired or wireless, and other protocols may be used as well.

The databases or other data stores described herein can be combined into fewer databases, or partitioned or divided into additional databases. In addition, the example processes described herein do not necessarily have to be performed in the described sequence, and not all states have to be reached or performed. Various database management systems or data formats may also be used, such as object-oriented database management systems, relational database management systems, flat files, text files, linked lists, arrays, and stacks. Furthermore, flags, Boolean fields, pointers, and other software engineering techniques or algorithmic procedures may be incorporated in the data management system to implement the features of the present invention.

Embodiments of the present invention may reside in the client side, in the server side, or in both places. Such embodiments, for example, program modules may be created using various tools as known in the art. For example, client side programming or manipulation may include programs written in various programming languages or applications, such as C++, Visual Basic, Basic, C, assembly language, FLASH™ from Macromedia, and machine language. Program modules interfacing with web browsers, such as plug-ins and MICROSOFT™ active X controls, Java Scripts, and applets may also be implemented. Server side modules may also be written in programming languages previously mentioned and including other server programming languages, such as Perl, Java, Hypertext Preprocessor (PHP), ColdFusion of Macromedia, etc. Databases shown residing, for example, on the server side may also reside or only reside on the client side. Similarly, databases discussed that may reside on the client side may also reside or only reside in the server side. Client and server refer to the client-server architecture.

What is claimed is:

1. A method for advertising, comprising:
receiving bid requests for advertisement (ad) placement, the bid requests including a bid amount and one or more of an ad type, a category, and a geographic area;
determining ad pricing for the ad placement using the bid requests in a dynamic price auction, wherein the ad pricing includes one or more of a floor price and an other ad price;
periodically modifying the ad pricing according to price correlation data among ads having different ad types; and
placing one or more ads in electronic ad spots according to the ad pricing.

2. The method of claim 1, further comprising providing a listing for the ad slots, the listing based on one or more of the category and the geographic area.

3. The method of claim 1, wherein the ad type includes one or more of a click ad type, a call ad type, and a call and click ad type.

4. The method of claim 1, wherein determining ad pricing for the ad placement using a dynamic second price auction comprises:
generating an expected value for each bid request;
selecting selected ads for ad placement according to the expected values, wherein the selected ads include at least one ad.

5. The method of claim 4, wherein selecting selected ads for ad placement according to the expected values comprises selecting a pre-specified number of ads having the highest expected values.

6. The method of claim 4, wherein the determining ad pricing for the ad placement using a dynamic second price auction further comprises:
determining the floor price to be a lowest bid amount among the selected ads;
assigning the floor price to an ad corresponding to the lowest bid amount; and
setting the other ad prices of each remaining selected ad relative to the floor price.

7. The method of claim 6, wherein setting the other ad prices comprises:
generating a first other ad price by adding a pre-specified monetary increment to the floor price;
assigning the first other ad price to a first ad of the selected ads, the first ad corresponding to a first incrementally higher bid amount relative to the lowest bid amount.

8. The method of claim 7, wherein setting the other ad prices comprises:
generating a second other ad price by adding the pre-specified monetary increment to the first other ad price;
assigning the second other ad price to a second ad of the selected ads, the second ad corresponding to a second incrementally higher bid amount relative to the first incrementally higher bid amount.

9. The method of claim 6, wherein setting the other ad prices comprises, for each selected ad other than the ad corresponding to the lowest bid, generating an other ad price approximately equal to a sum of a pre-specified monetary increment plus a bid that is immediately lower than a bid of the selected ad.

10. The method of claim 4, wherein generating an expected value comprises:
determining an ad conversion rate for an ad by dividing a number of inquiries to the ad by a number of times the ad is presented to users;
multiplying the ad conversion rate by the respective bid amount of the ad.

11. The method of claim 10, wherein the number of inquiries includes one or more of number of clicks received form the ad and the number of calls received from the ad.

12. The method of claim 4, further comprising assigning a prominence to the selected ads according to the expected values.

13. The method of claim 1, wherein the modifying of the ad pricing according to price correlation data among ads having different ad types approximately equalizes potential revenues from different ad types.

14. The method of claim 1, wherein the modifying of the ad pricing comprises:
determining a minimum bid value for each ad type in each geographic area;
modifying the determined minimum bid values of each ad type in response to historical data of each ad type, wherein the historical data includes one or more of ad leads, traffic search requests, and user patterns that include one or more of conversion rate, click-through rate, call rate, and number of ad impressions.

15. The method of claim 14, wherein modifying the determined minimum bid value comprises:
determining one ad type having the highest revenue among the ad types;
determining a factor by which revenue of the one ad type exceeds revenue of one other ad type;
dividing the floor price of the other ad type by the factor to generate a modified floor price for the other ad type; and
adjusting the floor price for the other ad type to equal the modified floor price.

16. The method of claim 1, wherein the ads include fixed-price ads, and further comprising providing an option for fixed-price advertising for set time periods for a subset of advertisers based on the auction bid prices.

17. The method of claim 16, further comprising allocating ad spots for ad placement among the bid requests and requests for the fixed-price advertising.

18. The method of claim 1, further comprising presenting a search result in response to a user query, the search result including the one or more placed ads.

19. A system comprising at least one advertising system coupled to a processor, the advertising system configured to receive bid requests for advertisement (ad) placement, the bid requests including a bid amount and one or more of an ad type, a category, and a geographic area, the advertising system configured to determine ad pricing for the ad placement using the bid requests in a dynamic price auction, wherein the ad pricing includes one or more of a floor price and an other ad price, the advertising system configured to periodically modify the ad pricing according to price correlation data among ads having different ad types, and the advertising system configured to place one or more ads in electronic ad spots according to the ad pricing.

20. The system of claim 19, wherein the ad type includes one or more of a click ad type, a call ad type, and a call and click ad type.

21. The system of claim 19, wherein configured to determine ad pricing for the ad placement using a dynamic second price auction comprises configured to:
generate an expected value for each bid request;
select selected ads for ad placement according to the expected values, wherein the selected ads include at least one ad.

22. The system of claim 21, wherein configured to determine ad pricing for the ad placement using a dynamic second price auction further comprises configured to:
determine the floor price to be a lowest bid amount among the selected ads;
assign the floor price to an ad corresponding to the lowest bid amount; and
set the other ad prices of each remaining selected ad relative to the floor price.

23. The system of claim 22, wherein configured to set the other ad prices comprises configured to generate at least one other ad price by adding a pre-specified monetary increment to one or more of the floor price and one other previously-determined other ad price.

24. The system of claim 22, wherein configured to set the other ad prices comprises, for each selected ad other than the ad corresponding to the lowest bid, configured to generate an other ad price approximately equal to a sum of a pre-specified monetary increment plus a bid that is immediately lower than a bid of the selected ad.

25. The system of claim 21, wherein configured to generate an expected value comprises configured to:
determine an ad conversion rate for an ad by dividing a number of inquiries to the ad by a number of times the ad is presented to users, wherein the number of inquiries includes one or more of number of clicks received form the ad and the number of calls received from the ad; and
multiply the ad conversion rate by the respective bid amount of the ad.

26. The system of claim 21, the advertising system further configured to assign a prominence to the selected ads according to the expected values.

27. The system of claim 19, wherein configured to modify the ad pricing comprises configured to:
determine a minimum bid value for each ad type in each geographic area;
modify the determined minimum bid values of each ad type in response to historical data of each ad type, wherein the historical data includes one or more of ad leads, traffic search requests, and user patterns that include one or more of conversion rate, click-through rate, call rate, and number of ad impressions.

28. The system of claim 27, wherein configured to modify the determined minimum bid value comprises configured to:
determine one ad type having the highest revenue among the ad types;
determine a factor by which revenue of the one ad type exceeds revenue of one other ad type;
divide the floor price of the other ad type by the factor to generate a modified floor price for the other ad type; and
adjust the floor price for the other ad type to equal the modified floor price.

29. The system of claim 19, wherein the ads include fixed-price ads, and further comprising providing an option for fixed-price advertising for set time periods for a subset of advertisers based on the auction bid prices.

30. Computer readable medium including executable instructions which, when executed in a processing system, manage advertising, by:
receiving bid requests for advertisement (ad) placement, the bid requests including a bid amount and one or more of an ad type, a category, and a geographic area;
determining ad pricing for the ad placement using the bid requests in a dynamic price auction, wherein the ad pricing includes one or more of a floor price and an other ad price;
periodically modifying the ad pricing according to price correlation data among ads having different ad types; and
placing one or more ads in electronic ad spots according to the ad pricing.
